(19) United States
(12) Patent Application Publication
(10) Pub. No.: US 2025/0329075 A1
(43) Pub. Date: Oct. 23, 2025

(54) SYSTEMS AND METHODS FOR SELECTIVE VISUAL DISPLAY OF MULTI-RESOLUTION ORDER BOOK AND OPTIMAL MARKET LIQUIDITY

(71) Applicant: Bullish Global, Grand Cayman (KY)

(72) Inventors: Khaled Al-Hassanieh, Blacksburg, VA (US); Justin Paul Short, Twickenham (GB); Samuel Hakim, Mid Levels (HK); Mark Woods, Radford, VA (US); Shashank Singh Solanki, Singapore (SG); Aditya Gopinath, Causeway Bay (HK)

(21) Appl. No.: 19/182,422

(22) Filed: Apr. 17, 2025

Related U.S. Application Data
(60) Provisional application No. 63/635,984, filed on Apr. 18, 2024.

(51) Int. Cl. G06T 11/20; G06Q 40/04

(52) U.S. Cl. CPC G06T 11/206; G06Q 40/04

(57) ABSTRACT

Embodiments described herein relate to computer systems and methods for virtual markets. The systems and methods involve a plurality of user devices associated with user accounts having an interface for providing order commands to the system for virtual markets. The systems and methods involve a processing system that includes one or more processors and one or more memories coupled with the one or more processors, the one or more memories storing an automated market maker, automated market maker instructions, depth chart data, routed markets, and so on. The one or more processors can execute order commands using routed markets.

### CROSS-REFERENCE TO RELATED APPLICATIONS

This application claims priority to and the benefit of U.S. Provisional Patent Application No. 63/635,984, entitled COMPUTER SYSTEM FOR VIRTUAL MARKETS, filed 18 Apr. 2024, the contents of which is hereby incorporated by reference.

### FIELD

The improvements generally relate to the field of distributed computer systems, visual displays, multicomputer data transferring, electrical computers and digital data processing systems, executable programs, dynamic information storage or retrieval, routing, trading platforms, blockchain infrastructure, and computer security.

### INTRODUCTION

Embodiments described herein relate to distributed computer systems to implement decentralized exchange platforms. Distributed computer systems raise technical challenges, such a latency issues, security concerns, resource management, and so on.

Embodiments described herein relate to visual interfaces for distributed computer systems and decentralized exchange platforms. Display devices raise technical challenges such as display size constraints, user experience for navigation of complex data sets, resource management, and so on.

Low liquidity in traditional trading platforms threatens the flexibility to execute large trades without significantly impacting market prices. This issue leads to higher transaction costs and increased price volatility, making it difficult for traders to maintain stable positions. Additionally, high market volatility can cause rapid changes in liquidity, complicating predictions and management.

Finding optimal liquidity across multiple markets is another significant challenge. Inefficient liquidity routing can limit trading opportunities and reduce capital efficiency, preventing traders from maximizing their potential returns. Poor liquidity management can also lead to forced liquidations and margin calls, resulting in missed trading opportunities and financial losses.

Therefore, a more efficient, stable, and user-friendly trading platform improving overall market performance and user satisfaction is desirable.

### SUMMARY

Distributed computer systems can implement decentralized exchange platforms. Embodiments described herein relate to improved exchange platforms for implementing an automated market maker, automated market maker instructions, multiple spread tiers, routed markets, virtual markets, liquidity routing, smart order routing, among other improvements.

In accordance with an aspect, there is provided a computer system for selective visual display of multi-resolution order books having a processing system that includes one or more processors and one or more memories coupled with the one or more processors, the one or more memories storing instructions for updating a visual display. In some embodiments, the processing system generates a multi-resolution order book and/or depth charts for the order book, wherein the user interface displays visual elements for the user accounts and the depth charts for the order book. In some embodiments, the processing system generates representations of different levels of the order book as different depths of the order book. The processing system can distribute or transmit the representations of the different levels of the order book to user devices for generating visual elements and updating a visual display system. This can improve use of transmission and storage resources, for example.

In accordance with an aspect, there is provided a computer system for selective visual display of a multi-resolution order book for a distributed exchange platform and an interface for routed markets, wherein the distributed exchange platform connects multiple devices to receive commands and provide data at the interface, the system comprising: a processing system that includes one or more processors and one or more memories coupled with the one or more processors, the one or more memories storing an automated market maker and automated market maker instructions, wherein the automated market maker instructions comprise code logic code that defines total quantities in a continuum of buy and sell orders within a specified price range, wherein the processing system is configured to: provide a hybrid order book that integrates the automated market maker with a central limit order book, wherein the automated market maker adjusts liquidity of the hybrid order book internally using the automated market maker instructions to manage buy and sell orders in the hybrid order book while avoiding latency issues and providing real-time data on the buy and sell orders, market depth, and price levels for assets, wherein the hybrid order book immediately reprices outstanding orders after a trade and before another trade occurs; provide one or more direct markets and one or more routed market for order execution wherein the routed market combines a plurality of markets based on a common quote asset, the routed market having a total liquidity of direct liquidity and routed liquidity, the routed liquidity being an implied liquidity value; execute one or more automated market maker instructions for the routed market based on an order indicating a base asset and a quote asset; provide a selective visual display of a depth chart as a representation for the hybrid order book, wherein a visualization of the depth chart reflects market depth of the hybrid order book in real-time with visual elements corresponding to order book depth, wherein the interface displays visual elements for the routed virtual market.

In some embodiments, the hybrid order book comprises data for the processing system to generate visual elements representing supply and demand of an asset at various price points.

In some embodiments, the interface receives input data for parameters of the one or more automated market maker instructions, and wherein the processing system is configured to configure the automated market maker instructions based on the input data for the parameters, wherein a parameter relates to a desired bid-offer spread.

In some embodiments, the interface is configured to zoom into different resolutions or levels of a depth chart which triggers visualizations of the depth chart with different scales or price points along an axis centred at a selected price point.

In some embodiments, the automated market maker selects one or more connector currencies for the one or more routed markets, and wherein the automated market maker switches between the one or more direct markets and the one or more routed market for order execution.

In some embodiments, the automated market maker applies spread for the bids and offers.

In some embodiments, the automated market maker instructions comprise a fixed spread, wherein the spread comprises a spread value for the fixed spread and a dynamic spread.

In some embodiments, the system has an automated market maker interface to receive or set parameters to generate the automated market maker instructions.

In some embodiments, the system has a derivative processor to manage perpetual positions. In some embodiments, the system has a spot processor. In some embodiments, the market-maker executes orders using spread tiers.

In some embodiments, the processing system provides one or more routed direct liquidity sources and one or more routed liquidity sources for order execution.

In some embodiments, the processing system generates depth charts for the order book, wherein the user interface displays visual elements for the user accounts and the depth charts for the order book.

In some embodiments, the automated market maker is configured to discretize long and short positions; hold consolidated perpetual positions; and distribute the perpetual positions to components of the system.

In some embodiments, the system has a plurality of user devices in communication with the interface, the user devices associated with user accounts, wherein a user device provides input data for the automated market maker instructions and configuration parameters; wherein the processing system receives input from the interface for an order request to buy or sell a desired quantity of assets; wherein the processing system generates output relating to the order request and the user accounts for transmission to interfaces of the user devices and displays visual elements at the interfaces of the user devices; and wherein a communication bus with a sequencer routes data and commands for the processing system.

In some embodiments, the market maker executes orders using a plurality of spread tiers, each with a different spread value.

In some embodiments, the processing system generates a depth chart for the order book specific to a user device, wherein the interface displays visual elements for the user accounts and the depth chart for the order book, wherein the depth chart comprises a bid/buy portion and an offer/sell portion, wherein the bid/buy portion shows the cumulative quantity of all buy orders placed on system at a given price point from the given price up to and including the best bid, wherein the offer/sell portion shows the cumulative value of the sell orders placed on system at a given price point from the given price down to and including the best offer, wherein an axis represents the price points at which buy and sell orders are placed for a particular market, and another axis representing the total volume that can be bought or sold, for the corresponding price.

In some embodiments, the automated market maker is configured to discretize long and short positions; hold consolidated perpetual positions; and distribute the perpetual positions to components of the system.

In an aspect, there is provided a computer implemented method for selective visual display of a multi-resolution order book for a distributed exchange platform and an interface for routed markets, wherein the distributed exchange platform connects multiple devices to receive commands and provide data at the interface, the method comprising: generating an automated market maker and automated market maker instructions, wherein the automated market maker instructions comprise code logic code that defines total quantities in a continuum of buy and sell orders within a specified price range; providing a hybrid order book that integrates the automated market maker with a central limit order book, wherein the automated market maker adjusts liquidity of the hybrid order book internally using the automated market maker instructions to manage buy and sell orders in the hybrid order book while avoiding latency issues and providing real-time data on the buy and sell orders, market depth, and price levels for assets, wherein the hybrid order book immediately reprices outstanding orders after a trade and before another trade occurs; providing one or more direct markets and one or more routed market for order execution wherein the routed market combines a plurality of markets based on a common quote asset, the routed market having a total liquidity of direct liquidity and routed liquidity, the routed liquidity being an implied liquidity value; executing one or more automated market maker instructions for the routed market based on an order indicating a base asset and a quote asset; and generating a selective visual display of a depth chart as a representation for the hybrid order book, wherein a visualization of the depth chart reflects market depth of the hybrid order book in real-time with visual elements corresponding to order book depth, wherein the interface displays visual elements for the routed virtual market.

In another aspect, there is provided a non-transitory machine readable medium having stored thereon a plurality of instructions that, when executed by at least one computing device, cause the at least one computing device to perform a method comprising: generating an automated market maker and automated market maker instructions, wherein the automated market maker instructions comprise code logic code that defines total quantities in a continuum of buy and sell orders within a specified price range; providing a hybrid order book that integrates the automated market maker with a central limit order book, wherein the automated market maker adjusts liquidity of the hybrid order book internally using the automated market maker instructions to manage buy and sell orders in the hybrid order book while avoiding latency issues and providing real-time data on the buy and sell orders, market depth, and price levels for assets, wherein the hybrid order book immediately reprices outstanding orders after a trade and before another trade occurs; providing one or more direct markets and one or more routed market for order execution wherein the routed market combines a plurality of markets based on a common quote asset, the routed market having a total liquidity of direct liquidity and routed liquidity, the routed liquidity being an implied liquidity value; executing one or more automated market maker instructions for the routed market based on an order indicating a base asset and a quote asset; and generating a selective visual display of a depth chart as a representation for the hybrid order book, wherein a visualization of the depth chart reflects market depth of the hybrid order book in real-time with visual elements corresponding to order book depth, wherein the interface displays visual elements for the routed virtual market.

In accordance with an aspect, there is provided a computer system for liquidity routing. In accordance with an aspect, there is provided a computer implemented method for liquidity routing with components, features or operations as described herein.

In accordance with an aspect, there is provided a computer system for automated market maker instructions. In accordance with an aspect, there is provided a computer implemented method for automated market maker instructions with components, features or operations as described herein.

Disclosed herein is a computer system for routed markets comprising: a processing system that includes one or more processors and one or more memories coupled with the one or more processors, the one or more memories storing an automated market maker and automated market maker instructions, wherein the automated market maker instructions comprise code logic that defines the total quantities in a continuum of buy and sell orders within a specified price range. The processing system is configured to: provide a hybrid order book that integrates the automated market maker with a central limit order book, wherein the automated market maker uses the automated market maker instructions to create bids and offers in the hybrid order book; provide a routed virtual market that combines a plurality of markets with a common quote currency, the routed virtual market having a total liquidity of direct liquidity and routed liquidity, the routed liquidity being an implied liquidity value.

In some embodiments, the automated market maker applies spread for the bids and offers. In other embodiments, the automated market maker instructions comprise a fixed spread, wherein the spread comprises a spread value for the fixed spread and a dynamic spread.

In some embodiments, the computer system further comprises an automated market maker interface to receive parameters to generate the automated market maker instructions.

In some embodiments, the computer system further comprises a spot processor. In some embodiments, the market-maker executes orders using spread tiers. In some embodiments, the processing system provides one or more routed direct liquidity sources and one or more routed liquidity sources for order execution.

In some embodiments, the processing system generates depth charts for the order book, wherein the user interface displays visual elements for the user accounts and the depth charts for the order book.

In some embodiments, the automated market maker is configured to discretize long and short positions; hold consolidated perpetual positions; and distribute the perpetual positions to components of the system.

Also disclosed herein is a computer system for virtual markets comprising a processing system that includes one or more processors and one or more memories coupled with the one or more processors, the one or more memories storing instructions for one or more direct markets, one or more routed markets, and one or more connector assets for the one or more routed markets.

Also disclosed herein is a computer system for virtual markets comprising: a plurality of user devices having an interface for the system, the user devices associated with user accounts, wherein a user device has an automated market maker interface to provide input data for automated market maker instructions and configuration parameters; a processing system that includes one or more processors and one or more memories coupled with the one or more processors, the one or more memories storing instructions for managing trading of the user accounts, wherein the processing system has a matching engine, a central limit order book and a market-maker, wherein the market-maker has an automated market maker and executes automated market maker instructions; wherein the processing system receives input from the interface for an order request to buy or sell a desired quantity of assets; wherein the processing system generates output relating to the order request and the user accounts for transmission to interfaces of the user devices and displays visual elements at the interfaces of the user devices; and wherein a communication bus with a sequencer routes data and commands to the engine.

In some embodiments, the market-maker executes orders using spread tiers.

In some embodiments, the processing system provides one or more routed markets for order execution.

In some embodiments, the processing system generates depth charts for the order book, wherein the user interface displays visual elements for the user accounts and the depth charts for the order book.

In some embodiments, the automated market maker is configured to discretize long and short positions; hold consolidated perpetual positions; and distribute the perpetual positions to components of the system.

Also disclosed herein are a computer implemented method for liquidity routing as described herein, a computer implemented system for liquidity routing as described herein, a computer implemented method for automated market maker instructions as described herein, and a computer implemented system for automated market maker instructions as described herein.

Also disclosed herein is a computer implemented method for virtual markets comprising: providing a processing system; receiving input from an interface for an order request to buy or sell a desired quantity of assets associated with one or more markets; executing, by the processing system, the order for the user account using automated market maker instructions; and generating output relating to the executed order for the user account for transmission to user interfaces of the user devices to display visual elements relating to the output.

Also disclosed herein is a non-transitory machine readable medium having stored thereon a plurality of instructions that, when executed by at least one computing device, cause the at least one computing device to perform a method for virtual markets as described herein.

Many further features and combinations thereof concerning embodiments described herein will appear to those skilled in the art following a reading of the instant disclosure.

### DESCRIPTION OF THE FIGURES

In the figures,

FIG. 1 shows an example schematic diagram of a distributed computer system for virtual markets according to some embodiments.

FIG. 2 shows a schematic diagram of a market-maker according to some embodiments.

FIG. 3 shows a schematic diagram of an example user interface for automated market making (AMM) instructions and depth charts according to some embodiments.

FIG. 4 shows an example schematic diagram of a distributed computer system for virtual markets according to some embodiments.

FIG. 5A-FIG. 5F show different market match configurations, according to some embodiments.

FIG. 6A and FIG. 6B show class structure diagrams for liquidity routing, according to some embodiments.

FIG. 7A and FIG. 7B shows a graph indicating a shift in liquidity resulting from the spread (top) and the OB depth of same (bottom), according to some embodiments.

FIG. 8 shows a graph indicating the Order Book (OB) depth with the limit price indicated thereon, according to some embodiments.

FIG. 9 shows a process diagram illustrating example operations for trade processing, according to some embodiments.

FIG. 10 shows a schematic diagram of liquidity routed market data design, according to some embodiments.

FIG. 11 shows a schematic diagram of a computing device, according to some embodiments.

FIG. 12A and FIG. 12B show a quote-base curve and corresponding price, according to some embodiments.

FIG. 13A and FIG. 13B show quote-base and liquidity-price graphs illustrating constant liquidity between an upper and a lower price limit, according to some embodiments.

FIG. 14 shows the effects of AMM instruction on overall liquidity, according to some embodiments.

FIG. 15 shows the levels of liquidity for different price ranges at multiple spread tiers, according to some embodiments.

FIG. 16 shows the mapping among direct, base, and quote market prices, according to some embodiments.

FIG. 17 shows a multi-resolution depth chart, according to some embodiments.

### DETAILED DESCRIPTION

Embodiments described herein relate to selective visual display of a multi-resolution order book for a decentralized exchange platform, an interface for routed markets, and improved exchange platforms for implementing an automated market maker, automated market maker instructions, multiple spread tiers, routed markets, virtual markets, liquidity routing, smart order routing, and so on

Embodiments described herein provide systems and methods for virtual markets involving a decentralized or distributed exchange platform for trading assets in a regulated environment. Embodiments described herein provide specific implementations to address regulatory considerations and scalability challenges, for example. Embodiments described herein relate to distributed computer systems that can implement decentralized exchange platforms. Embodiments described herein relate to an exchange platform that connects to electronic devices to receive commands and requests for transactions. Embodiments described herein provide systems and methods for optimizing capital efficiency of automated market makers, and maximizing market depth and liquidity. Embodiments described herein provide systems and methods for routing transaction commands to optimize liquidity, for example.

Embodiments described herein provide systems and methods for selective visual display of multi-resolution order books. In accordance with an aspect, there is provided a computer system for multi-resolution order books having a processing system that includes one or more processors and one or more memories coupled with the one or more processors, the one or more memories storing instructions for generating and distributing representations of the multi-resolution order books and selectively updating visual displays with renderings generated based on the representations.

An order book provides real-time data on buy and sell orders, market depth, and price levels for assets. The order book provides data to generate representations to visualize the supply and demand of an asset at various price points, for example.

In some embodiments, the processing system generates depth charts for the order book, wherein the user interface displays visual elements (e.g. at a visual display) for the user accounts and the depth charts as representations for the order book. In some embodiments, the processing system generates representations of different levels of the order book as different depths of the order book. The processing system can distribute or transmit the representations of the different levels of the order book to user devices. This can improve use of transmission and storage resources, for example.

The visualization of the depth chart reflects market depth in real-time with visual elements corresponding to the order book depth. A user device with a visual display screen can display the visualization at a user interface. A visual display system can implement the methods and operations described herein. The display screen has size constraints to limit the amount of information that can be displayed in the user interface. Embodiments described herein provide an improved user interface and visualizations for selective renderings of data of the depth chart.

A depth chart reflects market depth in real-time to visualize or show the depth of the order book, which combines the functionalities of an automated market maker (AMM) and a central limit order book. AMM executes code to generate prices for assets. This integration provides stability across variable market conditions.

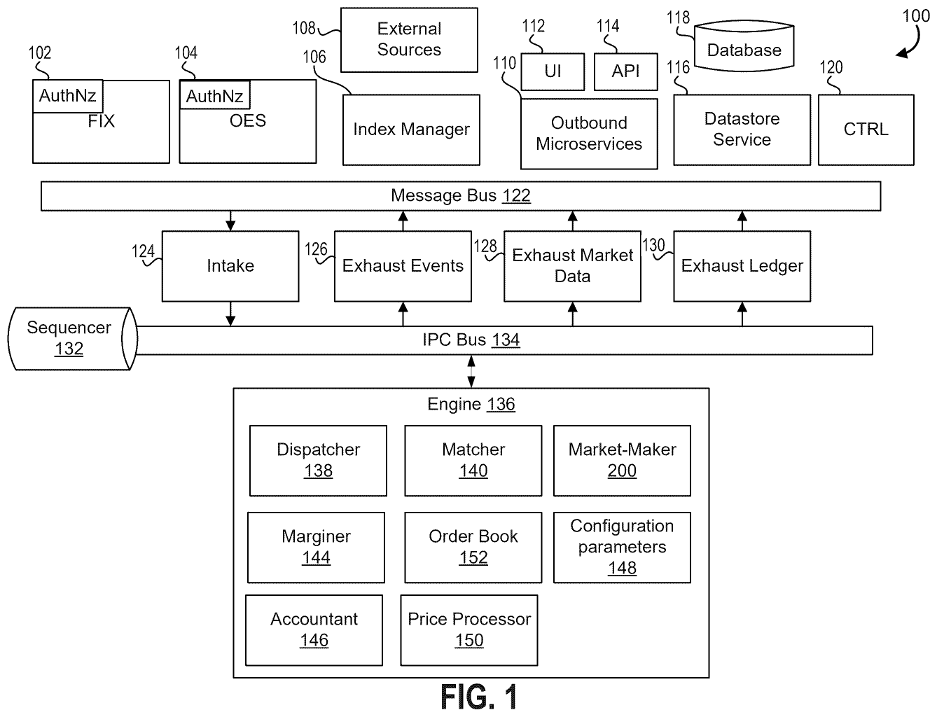

FIG. 1 shows a schematic diagram of a distributed computer system 100 according to embodiments described herein. The distributed computer system 100 can be referred to as an exchange platform herein. In operation, the exchange platform 100 of FIG. 1 may send order instructions to an engine 136 from FIX 102 and Order Entry Services (OES) 104 on the message bus 122 into intake 124. The intake 124 may transmit the data to the sequencer 132 (e.g., to provide with a universal identifier) and then to engine 136 through the IPC Bus 134. The dispatcher 138 may dispatch orders (e.g., buying and selling through the order executor), liquidity orders, account executors which may all be requested with the sequencer 132.

The system 100 provides an improved order book 152 integrated with automated market maker (“AMM”) instructions. The system 100 provides an improved order book 152 to efficiently use network, transmission, processing and storage resources, for example. The order book 152 can provide real-time data on orders, market depth, and price levels for assets. The order book 152 provides data for system 100 to generate representations to visualize the supply and demand of an asset at various price points, for example. The system 100 may optimize the use of computing resources and improve latency issues. For example, there may be network bandwidth constraints and system 100 may optimize the use of network bandwidth.

System 100 integrates the Order Book 152 with the Market Maker 200 and the subsidiary AMM 210 to allow every bid and offer to be immediately repriced (if necessary) after every single trade, before any new trades can occur. Every bid and offer is priced and sized according to the system 100. This is in contrast to traditional market-making using limit orders sent via an application programming interface (API), which are bandwidth constrained and subject to latency issues. AMM 210 is programmed to adjust liquidity internally using codified equations as opposed to sending/receiving orders or requests to cancel/amend orders via an API. Accordingly, AMM 210 is not impacted by latency issues for orders or requests from the API.

Conventional orderbooks can have thousands of orders sent by various customers. Orders which rest in a conventional order book (e.g. maker orders) may stay in the order book at the instructed price and residual quantity until otherwise instructed (e.g. until the customer cancels the order or amends it by sending a further message over the API). Every such instruction uses some network bandwidth and incurs some network latency, even if co-located. Co-location can reduce latency but there will still be some latency for all instructions. Some exchanges support “bulk” instructions (e.g. bulk new, bulk amend, bulk cancel) which reduces the bandwidth required for a given single order. However, this does not address latency issues. System 100 can generate and use AMM Instructions in virtual markets, where data from multiple markets are combined by the system. The AMM Instructions can amend all liquidity in the orderbook (e.g. all orders) instantly and atomically. System 100 can generate AMM instructions and parameters to define the entire price curve. System 100 can fill liquidity on the offer side and then automatically provide some liquidity for the bid side to redistribute the buy/sell liquidity. For example, one of the triggers for AMM Instructions to do so is receiving a fill order. Thus in terms of reactivity to events, AMM Instructions are neither bandwidth constrained, nor is there any latency. Accordingly, system 100 can provide reduced latency by integrating the Order Book 152 and AMM Instructions.

The system 100 can further include an engine 136 with a dispatcher package 138, matcher package 140, market-maker package 200, marginer package 144, order book 152, configuration parameter package 148, accountant package 146, and price processor 150. The order executor of the dispatcher 138 may send order requests into the matcher 140. The matcher may send requests to the market-maker 200 and the price processor 150.

Users may use web applications (e.g., a REST API or a FIX API) for virtual market transactions. On the exchange platform 100, users will be able to submit new orders and AMM instructions (e.g., through the AMM of market-maker 200). An order sent for a trading account may be filled, partially or in whole.

The dispatcher package 138 can route commands and data to different execution paths and/or different components. The dispatcher package 138 can include different components such as: the margin trigger, the loan executor, the liquidation trigger, the order executor, the account executor, automated market maker trigger, the liquidity order executor, the MTM trigger, the common special trigger, and the special trigger executor.

The matcher package 140 includes a matching engine that can execute transactions (e.g., an order match). The matcher package 140 can include different components such as: the fills processor, the matching engine, the dispatcher OMS drive, and integrates with the order book 152.

The market-maker package 200 can generate and manage prices and quantities for the markets. The market-maker package 200 can be an automated market maker (AMM). The market-maker package 200 receives inputs from the dispatcher 138 and the matcher package 140. System 100 can process orders using a hybrid order book (e.g. order book 152) that integrates a central limit order book with AMM instructions.

The marginer package 144 manages and stores trading product components (e.g., derivative positions, derivative orders, derivative AMM instructions, perpetuals positions, perpetuals orders, perpetuals AMM instructions, margin lending and borrowing), risk management (e.g., the risk engine), and related data. The marginer package 144 receives inputs from the dispatcher package 138 and the accountant package 146, and outputs to the sequencer 132. The marginer package 144 can include different components such as: the marginer processor, the margin data, the loan instruction, the liquidation dealer, and the insurance fund. The system 100 and marginer package 144 may share description and variations and be compatible with components as described in U.S. patent application Ser. No. 18/793,679, entitled COMPUTER SYSTEM FOR ON-DEMAND MARGIN BORROWING AND LENDING, filed 2 Aug. 2024, the contents of which is hereby incorporated by reference.

The configuration parameter package 148 generally provides inputs to control the configurations of the account, assets, exchanges, institution, and markets. The configuration parameter package 148 can include different components such as: the trading account data config parameters, the institution config parameters, the asset config parameters, the market config parameters, and the exchange config parameters.

The accountant package 146 can implement accounting related functionalities. The accountant package 146 can generally be customized to each account within the system 100. The accountant package 146 can include different components such as: the asset accountant and the asset account. The accountant package 146 may receive inputs from the configuration parameter package 148, the matcher package 140, the dispatcher package 138, the marginer package 144, the market-maker package 200, and the price processor package 150. The accountant package 146 receives inputs and outputs to the marginer processor 144 when a lender is lending, a borrower is borrowing, or a repayment is being made. The accountant package 146 also receives inputs and outputs to the liquidation dealer as a solvency check.

The price processor package 150 is configured for calculating and providing the different prices for the system (e.g., the mark price, the index price, the market price). The price processor package 150 can include different components such as: the price processor and the index price processor.

### Automated Market Maker Instructions

The distributed computer system 100 has a market-maker package 200. The market-maker package 200 can generate and manage prices and quantities for the markets. The market-maker package 200 can receive inputs from a dispatcher (such as dispatcher 138) and a matcher package (such as matcher 140).

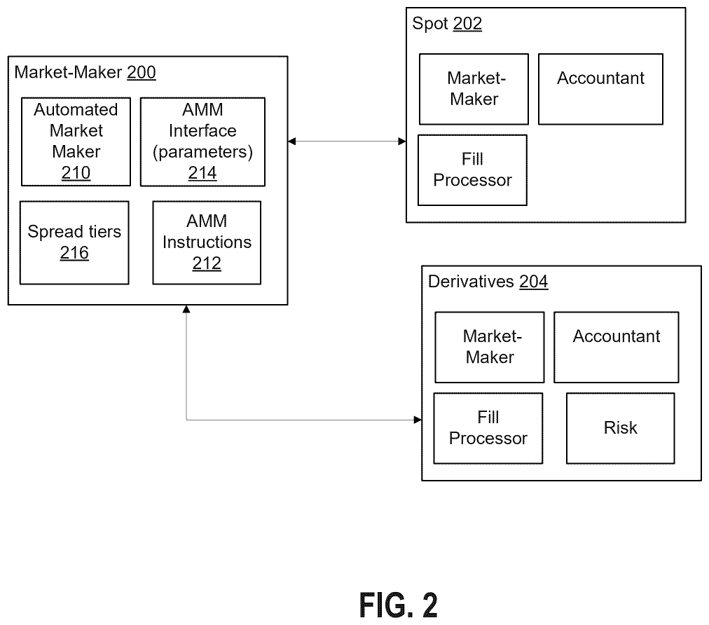

FIG. 2 shows a schematic diagram of a market-maker package 200 according to some embodiments. The market-maker package 200 has an Automated Market Maker (AMM) 210, AMM instructions 212, an AMM interface 214, and spread tiers 216. The market-maker package 200 can set risk controls. System 100 provides deep liquidity in markets by combining an AMM 210 with a limit order book (collectively referred to as the “Order Book”).

The distributed computer system 100 provides an improved AMM 210 implementation that considers regulatory requirements. AMM 210 can automate trading and order execution using smart contracts, markets, and liquidity pools. AMM 210 converts liquidity available to the system 100 in the form of AMM instructions 212 into bids and offers for placement. Once placed, the bids and offers create predictable depth across varying market conditions and regulatory requirements.

Liquidity can represent the shares in the reserves. Consider the following illustrative example:

Let b represent base and q represent quote, and variable k=q×b. Liquidity could then be defined as l=\sqrt{k}, and reserves value as q+p×b=2q for a 50:50 asset distribution for any price p∈(0, ∞). l is additive and represents the shares in the reserves. l is constant at any price. For this example:

$$p = 10 , 000 USD / BTC$$

$$account 1 deposits 1 BTC and 10 , 000 USD \text{=>} liquidity 1 = 100 ( BTC . USD ) \hat{} 0.5$$

$$account 2 deposits 3 BTC and 30 , 000 USD \text{=>} liquidity 2 = 300 ( BTC . USD ) \hat{} 0.5$$

For this example the total_liquidity=100+300=400

$$share of account 1 = liquidity 1 / total\_liquidity = 0.25$$

$$share of account 2 = liquidity 2 / total\_liquidity = 0.75$$

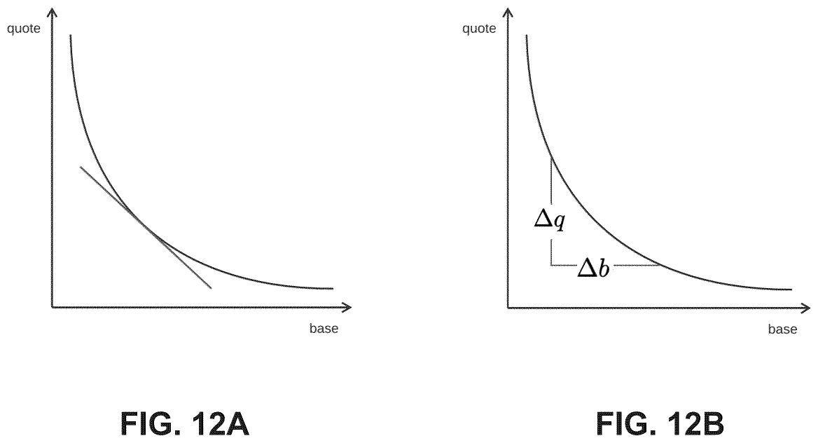

The relationship between quote, base, and price is illustrated by FIG. 12A, wherein a simplified and exemplary quote-base curve is shown. The tangent line represents b/q, the negative value of which is price.

FIG. 12B further illustrates buying and selling activities, which are graphically represented by movements along the quote-base curve. Buying corresponds to a Δb which would incur a cost of:

$$Δ q = Δ b \frac{q}{b - Δ b}$$

And selling a Δb results in a proceed of:

$$Δ q = Δ b \frac{q}{b + Δ b}$$

The AMM maintains a constant relationship between the base amount b, quote amount q, liquidity l, and price bounds Pu and Pl. The invariant below ensures that the product of these terms remains constant, which is essential for maintaining the stability and predictability of the AMM system.

$$( b + \frac{l}{\sqrt{{p}_{u}}} ) ( q + l \sqrt{{p}_{t}} ) = {l}^{2}$$

Using the relationship between p, q, and b, the above equation can be rearranged as the following:

$$p = \frac{q + l \sqrt{{p}_{l}}}{b + l / \sqrt{{p}_{u}}}$$

Wherein, for p falling within different price ranges, the values of b and q can be determined as:

$$\begin{matrix}If p < {p}_{l} & \\ & b = l ( \frac{1}{\sqrt{{p}_{l}}} - \frac{1}{\sqrt{{p}_{u}}} ) \\ & q = 0\end{matrix}$$

$$\begin{matrix}If {p}_{l} \leq p \leq {p}_{u} & \\ & b = l ( \frac{1}{\sqrt{p}} - \frac{1}{\sqrt{{p}_{u}}} ) \\ & q = l ( \sqrt{p} - \sqrt{{p}_{l}} )\end{matrix}$$

$$\begin{matrix}If p > {p}_{u} & \\ & b = 0 \\ & q = l ( \sqrt{{p}_{u}} - \sqrt{{p}_{l}} )\end{matrix}$$

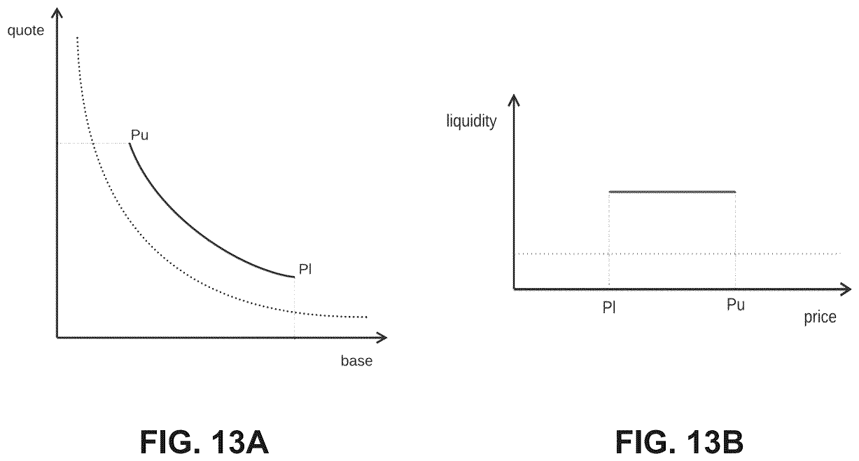

The invariant relationship is further illustrated in FIG. 13A, in which the price limits are graphically represented by the curve segment on the quote-base graph bound by derivative values corresponding to Pu and Pl. The resulting amplified reserves is shown as a constant liquidity within each price bucket [Pu, Pl] as shown in FIG. 13B. The liquidity generated by a constant-product AMM translates into base and quote reserves moving on a hyperbola as exemplified by the two curves.

An AMM instruction 212 can be regarded as code that defines the total quantities in a continuum of buy and sell orders within a specified price range. System 100 can execute AMM instructions 212 for direct and routed markets. Each set of AMM instruction 212 includes an upper price limit (Pu) and a lower price limit (Pl), which are integer multiples of the liquidity tick size (e.g., 100.0000 USD for BTCUSD). These price limits help manage liquidity within specific ranges. The AMM instructions 212 can also specify the base or quote amount, the composition of the deposit (i.e., base, quote, or a mixture of both) based on the current price relative to the limits, and spread tier.

For example, if the current price P falls within the range [Pl, Pu], the base amount is specified. Liquidity is then calculated using P, Pu, and the base amount. Similarly, the quote amount is calculated using liquidity, Pl, and P. For each liquidity bucket in [Pl, Pu), total liquidity is then updated and the new AMM instruction data is added. In some embodiments, the state of each liquidity bucket (tick) includes: start price, total liquidity (visible to buy/sell orders), fee pool, list of AMM instructions that overlap with the bucket, and other accounting fields.

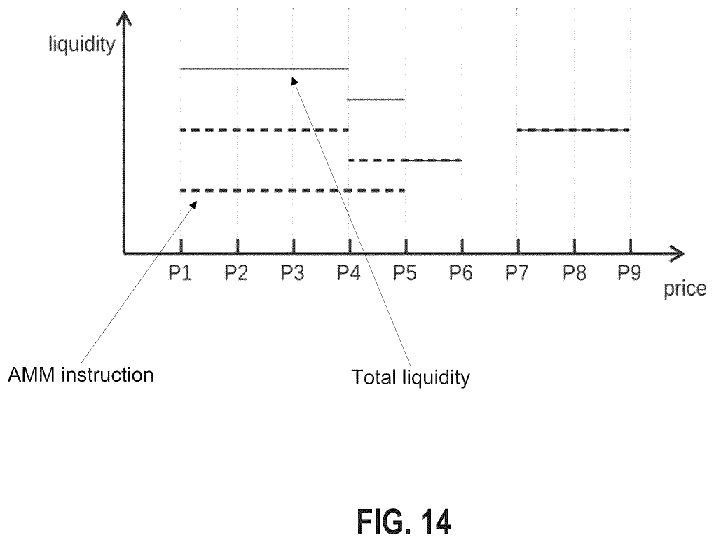

FIG. 14 shows the effects of the AMM instruction on the overall liquidity, in some embodiments. Over a range of different price points Pn, the total liquidity may vary but the liquidity within a price bucket remains constant. Individual AMM instruction contribute to the total liquidity.

In execution, trading against the AMM can have the following buy and sell values within the AMM system with initial and final prices pi and pf:

### For Buy Trades:

$$Δ b = l ( \frac{1}{\sqrt{{p}_{i}}} - \frac{1}{\sqrt{{p}_{f}}} )$$

$$Δ q = l ( \sqrt{{p}_{f}} - \sqrt{{p}_{i}} )$$

### For Sell Trades:

$$Δ b = l ( \frac{1}{\sqrt{p f}} - \frac{1}{\sqrt{{p}_{i}}} )$$

$$Δ q = l ( \sqrt{{p}_{i}} - \sqrt{{p}_{f}} )$$

The AMM 210 uses AMM instructions 212 sent by customers or users to create the firm bids and offers for virtual markets and liquidity pools. Customers can send multiple AMM instructions 212, for multiple markets, subject to their account balances. Each individual AMM instruction 212 directs the AMM 210 on how to place multiple bids and offers into the Order Book, using assets from the customer's account.

AMM 210 is configured to automatically determine what price and quantity to buy or sell assets at. The AMM 210 can then apply an additional spread to the base formula—e.g., pricing bids lower by half a spread and offering higher by half a spread—to generate the actual bids and offers for the Order Book. The spread is a combination of the Fixed Spread in the AMM instruction 212 and an optional dynamic spread.

As other market participants trade against bids and offers sent on behalf of the multiple customer AMM instructions 212, each one of those trades can generate income for one or more AMM instructions 212. Since there are often multiple AMM instructions 212 active at the same time, translating to bids and offers at the same price, the income from each trade is split among the AMM instructions 212 involved in the trade according to how much value it contributed to the trade.

As an illustrative example, there can be an AMM instruction 212 for a particular market, such as the BTC/USD market. The following is an example formula converting quote assets to base assets:

$$Quote = Base \cdot \sqrt{Price \cdot Upper} \frac{( \sqrt{Price} - \sqrt{Lower} )}{( \sqrt{Upper} - \sqrt{Price} )}$$

The example constant product formula provides, given the current Price and supplied Upper and Lower price bounds, how much USD (Quote) is needed to allocate the AMM instruction 212 in addition to the BTC (Base) chosen to allocate.

System 100 can provide dynamic spread logic. AMM instructions 212 can have parameters that can be configured by AMM interface 214. For example, the AMM interface 214 and AMM instructions 212 allow customers to select a desired bid-offer spread (e.g. the distance between the highest bid and lowest offer that will be sent for that AMM instruction 212). However, in certain market conditions, a single fixed spread is suboptimal. For instance, after the exchange maintenance window, the AMM instruction 212 price might have become outdated. To ensure liquidity is provided at a price more aligned with global consensus, dynamic spread can adjust bids and offers accordingly. Similarly, when the price trends up (down) and customers are selling (buying) more frequently than normal, it can be advantageous to temporarily raise offers (lower your bids) until the market stops trending. Dynamic spread logic can adjust spread based on recent market conditions.

AMM instructions 212 can allow customers to directly make markets using idle assets and generate income. AMM interface 214 can be used to create one or more AMM instructions 212 for one or more markets. Each AMM instruction 212 has parameters (configurable using AMM interface 214) to capture e.g. trading strategy and risk profile. Example parameters can include:
A price range for bids and offers
A minimum bid/offer spread
Optional dynamic spread adjustments

After submitting AMM instructions 212, the system 100 can be fully automated using the parameters supplied in the AMM instructions 212. The AMM instructions 212 can be terminated.

By submitting an AMM instruction 212, the system 100 instructs the AMM 210 to make a market on behalf of a user by continuously managing bid and offer orders. System 100 tracks and records transaction data when other market participants trade against bids and offers and the AMM 210 will immediately and automatically reprice orders upon every trade.

AMM instructions 212 can indicate minimum bid/offer spread, price range, etc. There can be multiple AMM instructions 212 with different parameters. After creating and submitting AMM instructions 212, the AMM 210 will immediately place multiple bids and offers across the defined price range. If the market is not trading within the price range, then the bids and offers will not be filled. When the market is trading within the price range once again, other market participants will be able to trade against the bids and offers sent by the AMM.

System 100 has an AMM interface 214 to create AMM instructions 212 and define parameters.

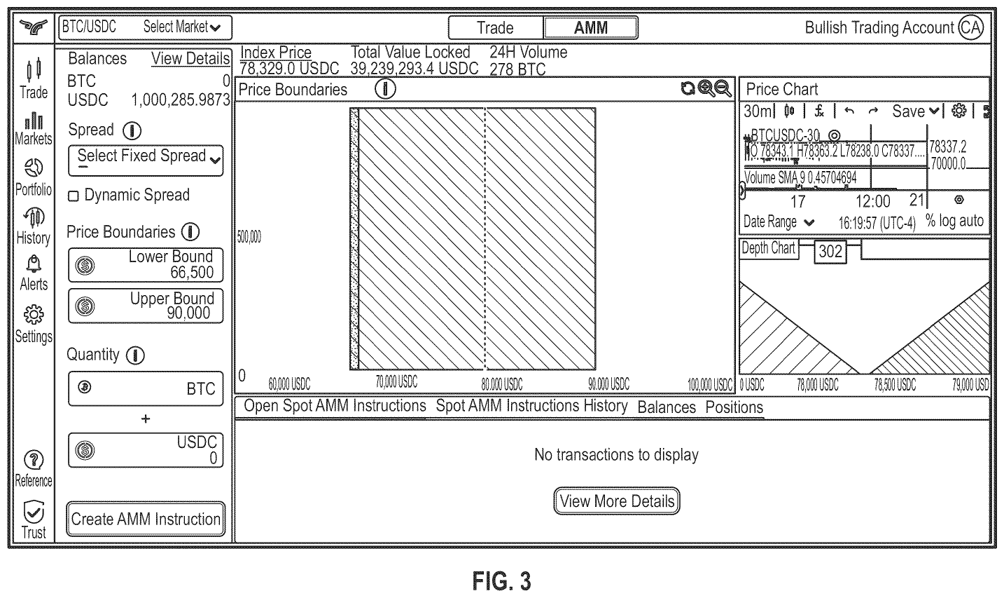

FIG. 3 shows a schematic diagram of an AMM interface 214. Example parameters include: spread (e.g. bid/offer spread), a defined price range, and the amount of both assets to contribute.

The AMM interface 214 can receive parameters to configure and generate AMM instructions 212. The AMM interface 214 can send multiple AMM instructions 212 each with different parameters. By submitting an AMM instruction 212, system 100 can instruct the AMM 210 to make a market by continuously managing bid and offer orders.

After creating and submitting AMM instructions 212, the AMM 210 can automatically place multiple bids and offers across the defined price range. If the market is not trading within the defined price range, bids and offers will not be filled. When the market is trading within the price range once again, other market participants will be able to trade against the bids and offers sent by the AMM 210 on your behalf and this may generate additional income.

The AMM interface 214 can have a “trade” button for selection and an “AMM” button for selection which can trigger a visual update at the AMM interface 214 to display different parameters and corresponding data values. For example, the AMM interface 214 can display market pair parameters, spread parameters (e.g. fixed, dynamic), price boundaries parameters (e.g. min and max selectors to define lower and upper price boundary), and asset amount parameters (e.g. base and/or quote amount) to receive corresponding data values to configure the parameters.

Once all of the parameters have been set, then values for the parameters can be received at the AMM interface 214 (e.g. via a Submit button in the window). This will send parameters to the engine 136 and immediately place bids and orders into the market. System 100 can terminate an existing AMM instruction 212 and/or send a new AMM instruction 212. The AMM interface 214 can also display all open AMM instructions 212.

The market-maker package 200 can interact with a spot processor 202 (e.g. spot market) and a derivative processor 204 (e.g. perpetual market). For example, AMM 210 can communicate with a derivative processor 204 when an account deposits liquidity in the AMM 210 for perpetuals in a certain price range (e.g. to fulfill an order against the liquidity bucket it may be short by some amount of currency, so if Alice has 25% liquidity then Alice will be 25% of that short position, e.g., 25 cents of $1). The derivative processor 204 can manage perpetual data, perpetual positions, and a risk calculator. The derivative processor 204 can manage all the perpetual positions (e.g., there may be multiple positions and the perpetual processor can manage these different positions). Further details regarding the derivative processor and perpetuals are provided in U.S. patent application Ser. No. 18/961,931 entitled COMPUTER SYSTEM FOR DISTRIBUTED COMPUTER ARCHITECTURES WITH EXCHANGE OF PERPETUAL FUTURES, filed Nov. 27, 2024, the contents of which is hereby incorporated by reference.

Perpetual positions may be liabilities that potentially require some amount of margin to support the position. Perpetual orders and AMM instructions 212 may also be liabilities that potentially require additional margin to avoid being rejected up front or cancelled later by the risk processor. Perpetual positions' unsettled profits or losses may impact the risk calculations. Finally, spot debts may also be included in the same calculations. The risk calculator can include a risk engine and can integrate with the marginer 144. In some embodiments, the risk calculator can include the following example functions: calculateRiskOnNewOrder( ), calculateRiskOnTransfer( ), calculateRiskOnWithdraw( ), and calculateRiskOnAmml( ).

Creation of perpetual market AMM instructions 212 (e.g. for perpetual processor 204) may be functionally similar to spot market AMM instructions (e.g. for spot processor 202) and carried out by respective market-makers. However where the spot market may require a value or an amount of an underlying source (or base asset) and an amount of the quote asset to be specified and locked up (dependent on the parameters chosen by the user, and the system logic), the perpetual market AMM instruction specifies how many more contracts they are prepared to buy and/or sell on top of their current underlying perpetuals position—the equivalent of sending a number of limit orders for the perpetual market. Just like sending multiple buy and sell limit orders, a perpetual market AMM instruction may also have a margin requirement. In addition, whereas assets deployed to and bought/sold by a spot AMM instruction may be kept quite separate from the other assets in the trading account, any fills received as a result of open perpetual AMM instructions may adjust the given trading account's position for the given contract.

Multiple AMM instructions 212 can be opened at the same time and their effects are cumulative. Once an AMM instruction(s) 212 automatically buys or sells contracts and causes a user's trading account's position to be long or short, it can behave as if that position had been manually entered by trading directly (i.e. via UI or API). Therefore, standard margin requirements may apply to that position and profits and losses may accrue from that position, both from market movements and from funding amounts.

Similar to some spot market AMM instructions, perpetual market AMM instructions can be terminated at any time. Terminating a perpetual market AMM instruction may simply reduce the margin requirement and may guarantee that AMM instruction 212 may not impact a position in the future. Note that the trading account's position may be unaffected when the AMM instruction 212 is terminated.

### Depth Chart/Multi-Resolution Order Book

System 100 can generate depth charts for the order book 152. A user interface (e.g. AMM interface 214) displays visual elements for depth charts for the order book 152. System 100 can generate representations of different levels of the order book 152 as different depths of the order book 152. System 100 can distribute or transmits the representations of the different levels of the order book 152 to user devices for display at a user interface. This can improve use of transmission and storage resources, for example.

The visualization of the depth chart reflects market depth in real-time with visual elements corresponding to the order book depth. A user device with a display screen can display the visualization at a user interface. In view of size constraints of the display screen, system 100 generates improved visualizations based the depth charts.

A Depth Chart reflects market depth in real-time to visualize or show the depth of the order book, which combines the functionalities of AMM 210 and a central limit order book to provide a hybrid order book 152. AMM 210 executes code to generate prices for assets. This integration provides stability across variable market conditions.

FIG. 3 shows a graphical user interface with an example depth chart 302 with a bid/buy portion on the left and an offer/sell portion on the right. The left side of the depth chart 302 shows the cumulative quantity of all buy orders placed on system 100 at a given price point from the given price up to and including the best bid. The right side of the depth chart 302 shows the cumulative value of the sell orders placed on system 100 at a given price point from the given price down to and including the best offer. The horizontal axis represents the price points at which buy and sell orders are placed for a particular market, and the vertical axes on both sides of the depth chart 302 represent the total volume that can be bought or sold, for the corresponding price.

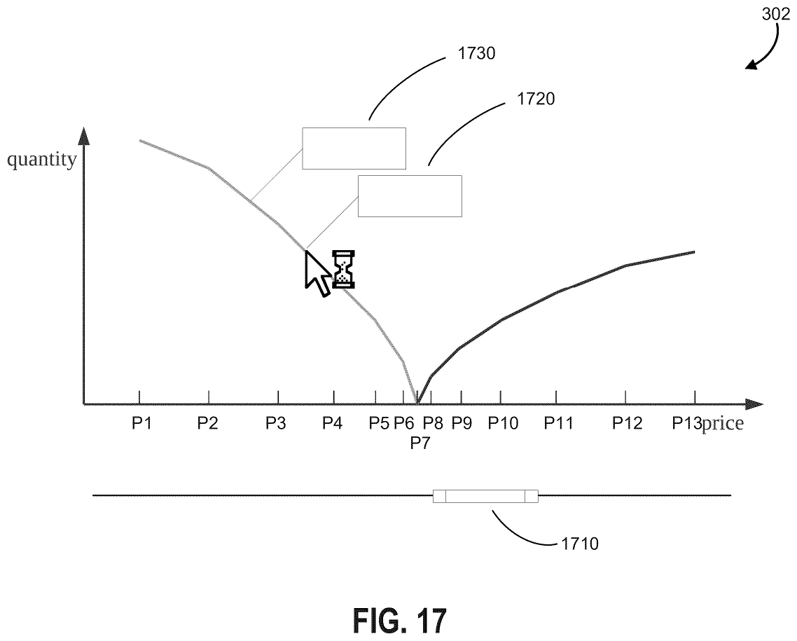

Embodiments described herein provide multi-resolution depth charts 302 for visualizations at an interface as shown in FIG. 3. FIG. 17 shows the multi-resolution depth charts 302 on its own. The interface can zoom into different resolutions or levels of a depth chart 302 which triggers visualizations of the depth chart with different scales or price points along the horizontal axis centred at a selected price point. Notably, the price points Pn are separated by identical values. However, the graphical user interface configures a portion of the axis labels to be less densely spaced to provide for an improved local resolution for a portion of the depth chart 302. The decision to amplify certain portions of the chart could be dynamically decided according to the nature of the data displayed or inferences drawn from user inputs. The interface can have selectable indicia 1710 to shorten or widen the price range displayed, and provides functionality to zoom in or zoom out.

In some embodiments, the depth chart 302 also has a market depth indicator which shows how much quantity can be bought or sold at the selected price at that instant in time, and the cost of executing the order if buying, or proceeds if selling. Note that other market participants are constantly buying and selling on the same market, which can affect the values actually available by the time any order is received.

For example, hovering over the left bid side of the chart in this example can trigger a display or indication that if a customer wants to sell around 137.30 BTC immediately to the bids shown, the BTC/USDC market price would then move down to 29,025 USDC, and the customer would receive just over 4.006 m USDC. Hovering over the right offer side of the chart in this example can trigger a display or indication that if a customer buys 100.67 BTC immediately from the offers shown, the BTC/USD market price would move up to 29,412 USDC, and the customer would need to pay approximately 2.959 m USDC.

The interface may provide a visualization of a crossed order book, meaning that the best bid has a higher or equal price to the best offer. This is common in traditional markets during auction phases, but is not as common in cryptocurrency markets. System 100 uses AMM Instructions to provide some of the liquidity, which are by definition market makers and cannot cross against each other. If this happens it can mean that there is a very good price available for anyone who wants to buy or sell. The opportunity does not usually last for very long.

The interface displaying the depth chart 302 can indicate a specific price point 1720 at which a user would like to place a limit or stop-limit order. Once they have selected an order type, then hovering over either side of the chart based on the order they wish to place (buy or sell) and choosing a specific price from the chart will automatically fill your limit price in the order.

Embodiments described herein provide a multi-resolution order book that can be used to generate the depth chart 302.

A normal order book has a list of prices and quantity of assets at that price. If a particular price point does not have the volume of assets desired for an order then system 100 can skip over that price point to the next price point and display to the user as alternative suggestion 1730. System 100 provides an improved way to compute the next price point or how much to jump or skip from the current price point to another price point. System 100 provides an improved way to generate a horizontal axis for the depth chart 302 with multiple price points and the placement of those price points along the axis. That is, system 100 determines where to put those price points along the axis of the depth chart. The price points Pn do not need to be evenly distributed along the axis. In some embodiments, system 100 generates a visualization of the price points such that the price points are shown further or wider apart (e.g. expanded view) centered around the price of interest (e.g. best bet/best offer), and as the price points are further away from the price of interest that are shown closer together (e.g. more compact). This improves the visualization of a large amount of data on a limited display screen size.

System 100 provides an improved multi-resolution depth chart by using a delta based model (e.g. only the change) to generate an update depth chart for a subsequent point in time and only transmits the difference or delta of the data. The delta is the difference in the order book 152 at a first point in time as compare to a second point in time. This reduces the bandwidth as the system 100 does not need to transmit the entire order book 152, only the difference or delta.

System 100 tries to determine or identify the “best bet/best offer” and then computes the delta close to this. The visualization will optimize the display of the areas that matter more (e.g. close to best bet/best offer) as compared to more extreme values. As noted, system 100 does not have to evenly distribute the price points on the axis and can condense/expand price points depending on how close or proximate they are to the best bet/best offer prices.

### Multiple Spread Tiers

System 100 provides improved spread implementation for AMM instructions 212. For example, system 100 can execute orders across multiple spread tiers 216. AMM 210 applies spread for the bids and offers.

Spread creates a difference between the lowest price to buy (best offer or best ask) and the highest price to sell (best bid). The spread value can be static or dynamic (changes with time and price). A process to add spread to the AMM has been developed. Multiple tiers can be provided, each with a different spread value. Each tier can be static or dynamic. When sending an AMM instruction 212, the user can choose the spread tier to which liquidity will be added. Lower spread means liquidity will be executed against first; whereas, higher spread means higher return for the AMM instruction 212. When filling an order against AMM 210, all tiers can be executed against simultaneously in a way that gives the best order execution price.

For each tier, spread can be implemented by shifting the liquidity up (for buying trades) or down (for selling trades) and by scaling the liquidity using the following equations:

### For Buy Trades:

$$p \to {p}^{′} = {F}_{o} p = ( 1 + {f}_{o} ) p$$

$$l \to {l}^{′} = \sqrt{{F}_{o}} l$$

### For Sell Trades:

$$p \to {p}^{′} = p / {F}_{b} = p / ( 1 + {f}_{b} )$$

$$l \to {l}^{′} = \sqrt{{F}_{b}} l$$

where p is the price, Fₒ is the total spread rate for the offer, fₒ is the spread rate for the offer, F_{b} is the total spread rate for the bid, f_{b} is the spread rate for the bid, and l is the liquidity.

For example, static spread tier with 20 bps spread: Fₒ=F_{b}=1.0020. As another example, dynamic spread tier with 10 bps spread: Fₒ=1.0010+g(t, p) and F_{b}=1.0010+h(t, p). Such spreads may shift liquidity, but not limit orders.

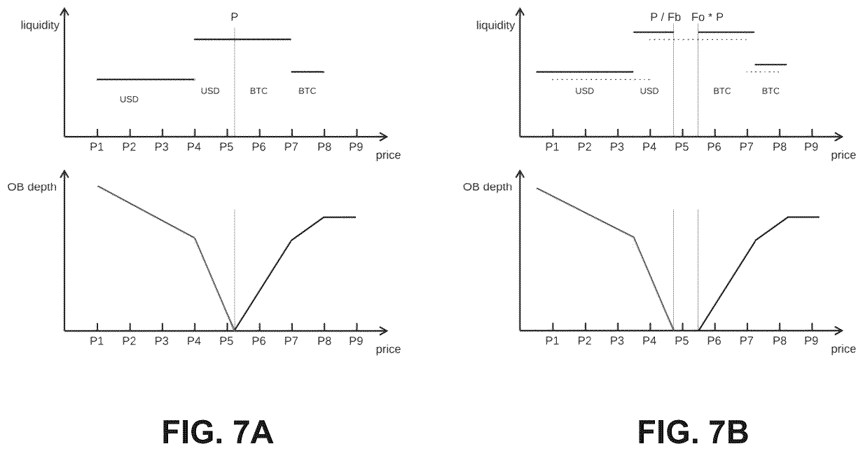

FIG. 7 shows a graph indicating a shift in liquidity resulting from the spread (top) and the OB depth of same (bottom), according to some embodiments. The user may only see the final price (e.g., higher for a buy order and lower for a sell order).

The available quantity may be found using the following equation:

$$Δ {b}^{′} = l ( \frac{1}{\sqrt{p}} - \frac{\sqrt{{F}_{o}}}{\sqrt{{p}_{limit}}} ) < l ( \frac{1}{\sqrt{p}} - \frac{1}{\sqrt{{p}_{limit}}} )$$

where pₗᵢₘᵢₜ is the limit price.

The cost may be found using the following equation:

$$Δ {q}^{′} = \underbrace{Δ {b}^{′} \frac{l \sqrt{p}}{\frac{l}{\sqrt{p}} - Δ {b}^{′}}}_{to AMM} + \underbrace{{f}_{o} Δ {b}^{′} \frac{l \sqrt{p}}{\frac{l}{\sqrt{p}} - Δ {b}^{′}}}_{ fees}$$

### For Sell Trades:

$$Δ {b}^{′} = \underbrace{Δ {b}^{′} / ( 1 + {f}_{b} )}_{to AMM} + \underbrace{{f}_{b} Δ {b}^{′} / ( 1 + {f}_{b} )}_{ fees}$$

The buyer can see spread/dislocation as an increase in price. The difference can be treated as a fee.

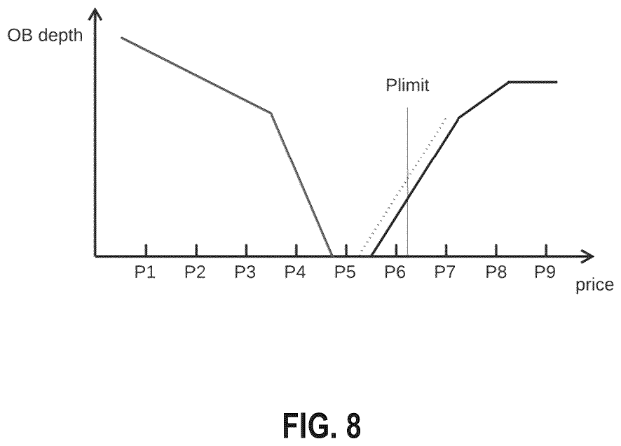

FIG. 8 shows a graph indicating the Order Book (OB) depth with the limit price indicated thereon, according to some embodiments. The downward curve at the lower price range represents a set of sitting buy orders (bids) and the upward curve occupying a higher price range represents a set of sitting sell orders (offers). The vertical dashed line is a limit order (from a central limit order book) with price Plimit in the same price range as the AMM.

In some embodiments, the system 100 can execute a buy trade against multiple spread tiers. The system 100 can sort the tiers by increasing the best offer. The system 100 can fetch the liquidity bucket in the first tier containing the current tier price. The system 100 can add the bucket liquidity to the running total liquidity. The system 100 can calculate the final price if the order quantity were to be executed against the total liquidity. The system 100 can then compare the final price to the limit price, current liquidity bucket end price, and next tier best offer. If the final price is smaller than the three, the system 100 may stop execution. If the limit price is the smallest, the system 100 may stop execution. If the current liquidity bucket end price is the smallest, the system 100 may replace it with the next bucket and repeat. If the next tier best offer is the smallest, the system 100 may include its current liquidity bucket and repeat.

In greater detail, the system 100 can be configured to provide optimal execution against multiple spread tiers. The steps for executing a buy order with quantity Q and limit price Pₗᵢₘᵢₜ are as follows:

Step 1: Start with the full set of spread tiers sorted by the best offer:

$$S = \{ {A}_{i} : 1 \leq i \leq N , and \sqrt{{F}_{o}^{( i )} {p}^{( i )}} \leq \sqrt{{F}_{o}^{( j )} {p}^{( j )}} for i < j \}$$

Pₘ can be defined as the running best offer. Initially:

$$\sqrt{{P}_{m}} = {min}_{{A}_{i} ∈ S} \sqrt{{F}_{o}^{( i )} {p}^{( i )}} = \sqrt{{F}_{o}^{( 1 )} {p}^{( 1 )}}$$

In addition, \tilde{S} can be defined as the set of active tiers. Initially, \tilde{S}=Ø. L can be defined as the running sum of the scaler liquidities of the currently active shifted liquidity buckets of \tilde{S}. Initially, L=0 and finally Pₑ can be defined as the lowest shifted end price of the active buckets in \tilde{S}. Initially, \sqrt{Pₑ}=∞.

Step 2: Add the first (so far) inactive tier with the lowest best offer, Aₖϵ(S−\tilde{S}), more specifically:

The current liquidity bucket can be found in the added tier,

$${p}^{( k )} ∈ [ {p}_{s}^{( k )} , {p}_{e}^{( k )} ] ,$$

and its liquidity added to L:

$$L ← L + \sqrt{{F}_{o}^{( k )}} {l}_{c}^{( k )} .$$

The bucket liquidity can be added to the running total liquidity:

$${l}_{total} ← {l}_{total} + {l}_{bucket}$$

$$\sqrt{{P}_{e}} ← min \{ \sqrt{{P}_{e}} , \sqrt{{F}_{o}^{( k )} {p}_{e}^{( k )}} \}$$

can be updated.
\tilde{S}←\tilde{S}∪{Aₖ} can be updated.

Step 3: Pₙ can be defined as the best offer of the next inactive tier:

$$\sqrt{{P}_{n}} = {min}_{{A}_{j} ∈ ( S - \tilde{S} )} \sqrt{{F}_{o}^{( j )} {p}^{( j )}}$$

Step 4: Pₚᵢᵥₒₜ can be defined as

$${p}_{pivot} = min \{ {p}_{final} , {p}_{limit} , {p}_{next - bucket} , {p}_{next - tier} \}$$

A guess for the final price can be calculated based on executing quantity Q against current running liquidity L:

$$\sqrt{{p}_{final}} = \{ \begin{matrix}\frac{{l}_{total} \sqrt{{p}_{ask}}}{{l}_{total} - Q \sqrt{{p}_{ask}}} , & {l}_{total} - Q \sqrt{{p}_{ask}} > 0 \\ ∞ , & otherwise\end{matrix}$$

And the following can be executed:

$$Q ← Q - {l}_{total} ( \frac{1}{\sqrt{{p}_{ask}}} - \frac{1}{\sqrt{{p}_{pivot}}} )$$

$${p}_{ask} ← {p}_{pivot}$$

\tilde{S} can be compared to Pₚᵢᵥₒₜ and the following cases can be considered:
If Pₚᵢᵥₒₜ=Pₗᵢₘᵢₜ, then all \tilde{S} up to min{\tilde{P}, Pₗᵢₘᵢₜ} can be executed then exit can occur.
If \tilde{P}≤Pₚᵢᵥₒₜ, then \tilde{P} can be filled up and exit can occur.
If Pₚᵢᵥₒₜ=Pₑ and \tilde{P}>Pₚᵢᵥₒₜ, then Pₚᵢᵥₒₜ can be filled up to:

$${Q}_{exec} = L \frac{\sqrt{{P}_{pivot}} - \sqrt{{P}_{m}}}{\sqrt{{P}_{pivot}} \sqrt{{P}_{m}}}$$

and Q←Q−Q_{exec} and Pₘ Pₚᵢᵥₒₜ updated. The next liquidity bucket of the tier corresponding to Pₑ can be fetched and Pₑ and L can be updated accordingly:

$$L ← L + \sqrt{{F}_{o}^{( j )}} ( {l}_{n}^{( j )} - {l}_{c}^{( j )} )$$

$${P}_{e} = {min}_{{A}_{k} ∈ \tilde{S}} {p}_{e}^{( k )}$$

$${l}_{total} ← {l}_{total} + {l}_{next - bucket} - {l}_{bucket}$$

and Step 4 repeated.
If Pₚᵢᵥₒₜ=Pₙ and \tilde{P}>Pₚᵢᵥₒₜ, then Pₚᵢᵥₒₜ can be filled up using

$${Q}_{exec} = L \frac{\sqrt{{P}_{pivot}} - \sqrt{{P}_{m}}}{\sqrt{{P}_{pivot}} \sqrt{{P}_{m}}}$$

and Q←Q−Q_{exec} and Pₘ←Pₚᵢᵥₒₜ updated and Step 2 repeated.

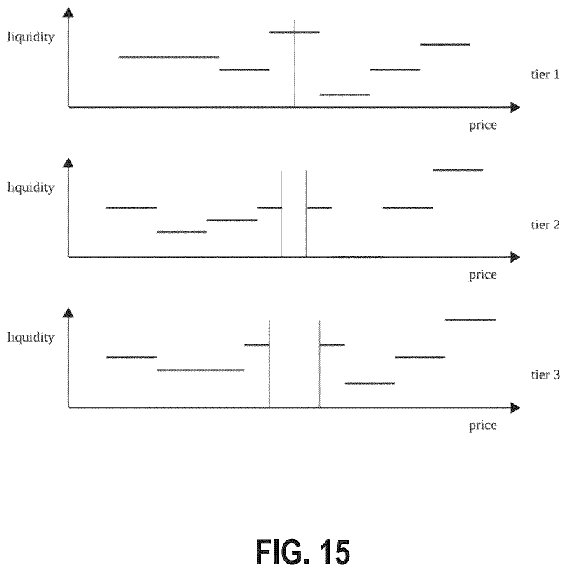

The process determines the price to fill up to in each tier. Execution is performed independently in each tier based on the determined price. The levels of liquidity for different price ranges as the process progresses through multiple tiers is shown in FIG. 15.

### Liquidity Routing

A direct market involves a single market and uses the same base and quote currencies as the overall market. In contrast, a routed market combines two or more direct markets with common quote currency/ies. Routed liquidity connects base and quote markets to the direct market, facilitating smoother transitions but demanding accurate information and timing considerations to prevent inefficiencies. System 100 provides for liquidity routing and routed markets. For example, market-maker 200 can implement routed markets for order execution. The market-maker 200 can switch from direct markets to routed markets. In some embodiments, the market-maker 200 must terminate existing AMM instructions 212 for that market. The market-maker 200 chooses a connector currency for the routed market. The market-maker 200 can also switch from routed markets to direct markets.

Liquidity routing can improve capital efficiency for both market-making customers and trading customers. Market makers may only need to supply liquidity to certain key markets and not to every listed market, even though they still receive the fills and profits when any market is traded. Traders can benefit from greater liquidity and depth and higher collateral valuations for their assets, further increasing their capital efficiency for margin and perpetuals trading.

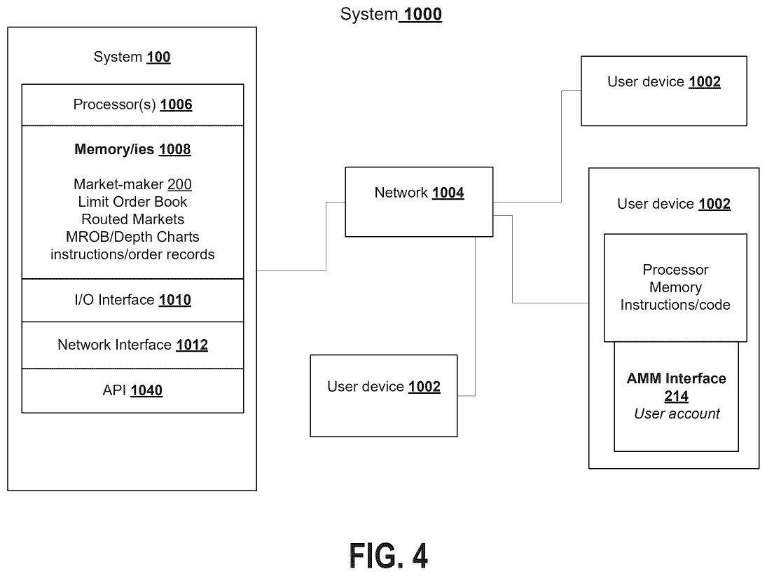

The trading interface of system 100 can receive order requests that include selections for [buy]/[sell] markets. An example is an order request for the ETH/BTC market to buy ETH and pay in BTC. A trading interface (e.g. interface of user device 1002 of FIG. 4) can receive a buy command along with a set price and set amount of data. System 100 can use routed markets and connector assets to execute trades for the order request. For example, system 100 can use [sell]/[routed] and [buy]/[routed] markets for the trade. As an illustrative example, the system 100 can use BTC/USDC market and ETH/USDC market to buy ETH and pay in BTC by selling BTC for USDC and then switching markets to buy ETH with the USDC. Accordingly, routed markets can automate the search for liquidity and the user will end up placing only one order on the EYH/BTC market instead of having to place two orders (one on BTC/USDC followed by ETH/USDC).

In some embodiments, a user can elect between using a direct market or a routed market. If a direct market is selected the order may be filled against the direct liquidity AMM for the market and filled against the direct limit Order Book for that market. If a routed market is selected (e.g., if ETH/BTC is a routed liquidity market and the route being via USDC), the simultaneous AMM buy (ETH/USDC) and AMM sell (BTC/USDC) order may be issued and the order may be filled against the direct Order Book for that market and the fill may be reported as an ETH/BTC fill.

System 100 automates use of markets using order routing to search for additional liquidity. System 100 uses market-maker 200 for routed markets, for example. A direct market can have AMM instructions 212. For a routed market, system 100 (e.g. market-maker 200) uses a connector asset or connector currency. A routed market can involve multiple connector markets quoted in the connector assets (e.g. BTC/USDC, ETH/USDC). A routed market can have no AMM instructions 212. System 100 uses direct markets and routed markets to fill taker orders instantly and rest maker orders in the Order Book, and uses AMM 210 liquidity. In some embodiments, a direct market can send AMM instructions, but a routed market cannot send AMM instructions.

If an order is a taker order, then, in a direct market, the system 100 can fill against the direct AMM, and also can fill against the direct limit Order Book. In a routed market (for instance routed via USDC) the system 100 can send simultaneous AMM buy (ETH/USDC) instructions and AMM sell (BTC/USDC) instructions, and also fill against the direct limit orderbook (ETH/BTC). Market-maker 200 can implement a direct market and routed market.

The system 100 tracks and records all instructions and orders (e.g. in memory 1008 of FIG. 4) for reporting. For example, system 100 can store and report the ETH/BTC fill. The system 100 can report what the taker sees (e.g. ETH/BTC fill or trade). If an order has a residual (e.g. a limit order and not fully filled) then system 100 can put the limit order in the Order Book.

The system 100 receives different types of order requests (e.g. limit, market, IOC). The system 100 can switch from direct markets to routed markets (e.g. using one or more connector currencies or assets and terminating all AMM instructions 212 for that market), and can switch from routed markets to direct markets.

The system 100 uses one or more connector currencies or assets for a routed market. The connector currency can be any custodied asset. The system 100 uses a direct market for base/connector and quote/connector. The following are examples:
ETH/BTC (connected via USDC) requires ETH/USDC and BTC/USDC markets
AAVE/ETH (connected via USDC) requires ETH/USDC and AAVE/USDC markets
SOL/BTC (connected via USDC) requires SOL/USDC and BTC/USDC markets
BTC/EURC (connected via USDC) requires BTC/USDC and EURC/USDC markets
BTC/USD (via USDC) requires BTC/USDC and USDC/USD

The system 100 stores records for all orders and instructions for reporting. For example, a taker order can be: Sell 20.002 ETH→Buy 1 BTC. There can also be maker orders: Sell 20.002 ETH→50,000 USDC, and Buy 1 BTC←50,000 USDC. The official trade fee for the aforementioned transaction can be ETH/BTC Sell 20.000 ETH for 1 BTC at price 0.05 BTC.

The system 100 may show no difference to the taker for either direct or routed flow: a taker order can be: Sell 20.002 ETH→Buy 1 BTC (pays 1dbp fee in ETH). In some embodiments, AMM 210 expects taker fees on every trade: Sell 20.002 ETH→50,005 USDC (AMM 210 expects a taker fee); Buy 1 BTC←50,005 USDC (AMM 210 expects a taker fee).

AMM instructions 212 can receive spread “fees”. For routed flow, only one “leg” may get the taker fee. Routed orders can have two underlying legs (1 buy leg and 1 sell leg). In the example described above, the sell leg is ETH/USDC and the buy leg is BTC/USDC. The trader (seller) can be charged in ETH as part of the taker fee. On the AMM 210, the fee may only be distributed to the sell leg (ETH/USDC). Buy orders can work the same way. On average the system AMM 210 may receive ½ the fee for virtual trades. Such configurations may expose the AMM 210 to more trades and generate returns with stablecoin pools. In some embodiments, on the spread portion, all markets' AMM instructions 212 may always receive spread “fees”.

The system 100 can additionally reduce arbitrage. If a trader performs arbitrage between BTC and USDC, they are indirectly affecting other trading pairs involving BTC, such as ETH/BTC, BTC/USDT, and BTC/USD. This is because the price movements in one pair can influence the prices in other pairs due to the interconnected nature of the routed markets. By reducing arbitrage opportunities in one pair, the system helps stabilize prices across multiple pairs, making it harder for traders to exploit price discrepancies.

The system 100 does not increase the number of USD trades by virtue of using USD as a connector currency (assuming traders continue to trade in USDC). However, the system 100 may report trades with the “USD value”: e.g., ETH/BTC Sell 20.000 ETH for 1 BTC at price 0.05 BTC, value 50,000 USD. Thus flows may be more easily included in indices or to run certain analyses, etc.

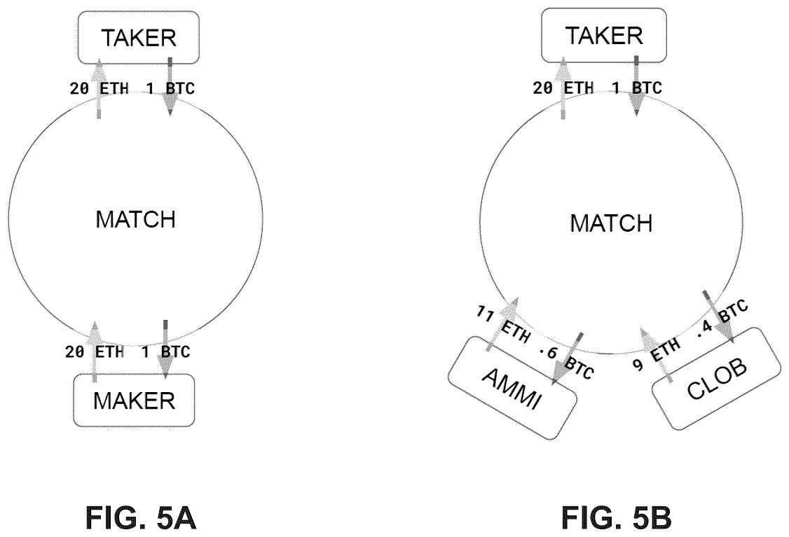

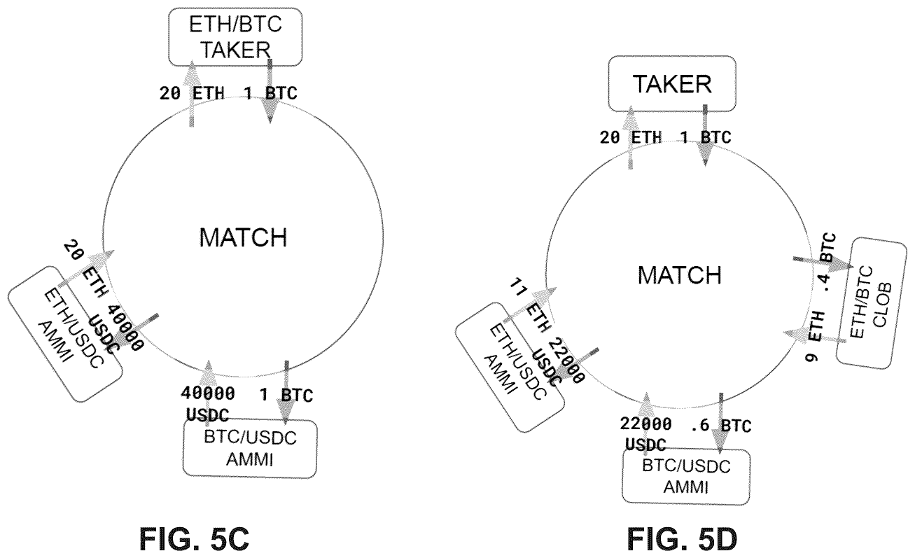

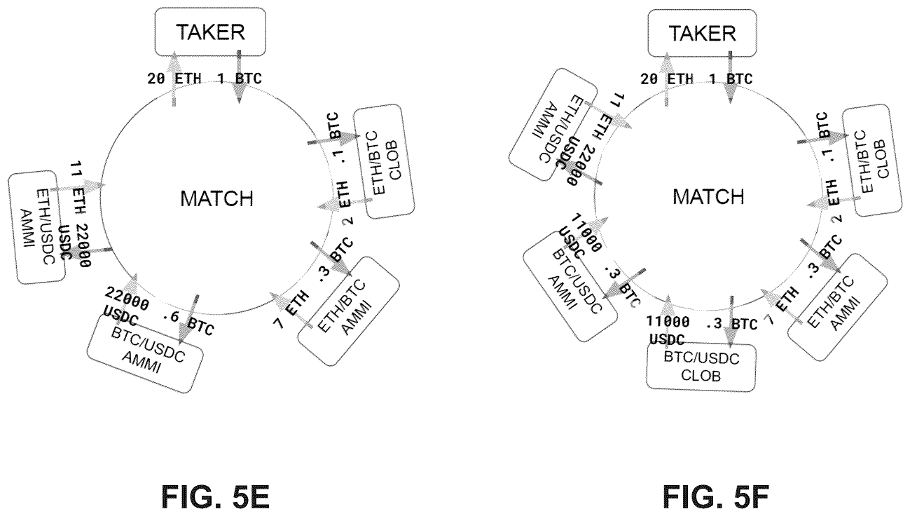

FIG. 5A is an example illustration of a single market environment. When a match happens, a transfer of assets in accounts between taker and maker is simultaneous and atomic. Such transactions have two or more counterparties. As illustrated, one taker supplies BTC and receives ETH and one or more makers supplies ETH and receives BTC. The reporting in such a situation may be an anonymous trade feed: Buy 20 ETH for 1 BTC. The taker fill may be: Buy 20 ETH for 1 BTC (same as trade feed). The maker fill(s) may depend on whether it's an AMM instruction 212 or not.

FIG. 5B is an example of a single market environment with a mix of liquidity sources. This example shows two liquidity sources: a direct central limit Order Book (CLOB) source and a direct AMMI source. A hybrid order book provides different sources of liquidity (e.g. CLOB and AMMI). The trade feed may be anonymous: Buy 20 ETH for 1 BTC (same as for FIG. 5A). The taker fill may be: Buy 20 ETH for 1 BTC (e.g. same as FIG. 5A). The maker fills for the CLOB may only be reported. In this example, the maker fill(s) may be: Sell 9 ETH for 0.4 BTC. AMMIs provide one or more maker fill(s). For liquidity routing (or virtual markets), the AMMIs can be in different currency than the initial taker request.

With the system 100, every match may result in one or more fills, one taker trade, and zero or more maker trades. A match may be a simultaneous atomic swap between multiple customers and/or accounts (e.g., ignoring exchange fees, a fill can be a report to the owner of an order that the order was partially or completely filled). That is, in some examples AMM instruction 212 does not receive fills. The reporting (anonymous trade feed) may be carried out as a taker trade being the result of sending a taker order, a maker trade being the result of a resting limit order being filled or an AMM instruction 212 providing liquidity (e.g., for a different market than the taker).

FIG. 5C is an example of a routed market environment with AMMI liquidity sources. In this example, there are no direct liquidity sources (e.g. no direct CLOB and no direct AMMI). For the routed market there are connector AMM instructions 212.

In liquidity routing (connector AMM instruction 212; see FIG. 5C), there may always be only one taker. The match shown in FIG. 5C has two makers and two maker trades: 1. ETH/USDC AMM instructions 212 (different market than taker) and 2. BTC/USDC AMM instructions (different market than taker). The fill can be reported for the taker: Buy 20 ETH for 1 BTC. The three trades can be reported: 1. Buy 20 ETH for 1 BTC taker; 2. Buy 1 BTC for 40,000 USDC maker; and 3. Sell 20 ETH for 40,000 USDC maker.

FIG. 5D is an example of a multiple market environment with direct and routed liquidity sources. For example, there is a direct CLOB liquidity source and a routed AMMI liquidity source. System 100 can implement a riskless principle so that the taker does not actually buy or sell the connector currencies (e.g. USDC). There may be additional regulatory restrictions applicable to different users that may prohibit buying or selling a particular currency, for example.

In liquidity routing (connector AMM instruction 212 and direct central limit Order Book, see FIG. 5D), there may always be only one taker. The match shown in FIG. 5D has three makers, but only two maker trades: 1. ETH/BTC central limit order book; 2. ETH/USDC AMM Instructions 212 (different market than taker); 3. BTC/USDC AMM Instructions 212 (different market than taker). The central limit Order Book fills can be reported as: 1. Taker: Buy 20 ETH for 1 BTC; 2. ETH/BTC central limit Order Book maker: Sell 9 ETH for 0.4 BTC. The three trades can be reported as: 1. Buy 20 ETH for 1 BTC taker; 2. Buy 0.6 BTC for 22,000 USDC maker; 3. Sell 11 ETH for 22,000 USDC maker.

FIG. 5E is an example of a multiple market environment with direct and routed liquidity sources. For example, there is shown both indirect AMMI liquidity source (e.g. BTC/USDC), a direct AMMI (EHT/BTC) liquidity source and direct CLOB (ETH/BTC) liquidity source. System 100 can create a direct AMMI on any market according to embodiments described herein. A hybrid order book provides different sources of liquidity (e.g. CLOB and AMMI). This example shows a direct AMMI (EHT/BTC) liquidity source and direct CLOB (ETH/BTC) liquidity source for a single market, and a routed liquidity source for another market (e.g. ETH/USDC, BTC/USDC).

In another example of liquidity routing (see FIG. 5E), there may be only one taker. The match shown in FIG. 5E has four makers, but only two maker trades: 1. ETH/BTC central limit Order Book; 2. ETH/BTC AMM instructions 212 (different market than taker); 3. ETH/USDC AMM instructions 212; and 4. BTC/USDC AMM instructions 212. The central limit Order Book fills can be reported as: 1. Taker: Buy 20 ETH for 1 BTC; and 2. ETH/BTC central limit Order Book maker: Sell 9 ETH for 0.4 BTC. The three trades can be reported as: 1. Buy 20 ETH for 1 BTC taker; 2. Buy 0.6 BTC for 22,000 USDC maker; and 3. Sell 11 ETH for 22,000 USDC maker.

System 100 processes AMMIs efficiently but there is still processing overhead. System 100 can process a (very) large number of AMMIs and make a finite (bounded) number of calculations. During trading, system 100 does not have to iterate through multiple instructions. The AMMIs improve performance of the system 100. System 100 can consider different pairs to fulfill the taker requests using AMMIs to provide more options. However, there may be difficulty in routing as there are multiple options for fulfilling the order and some may require intermediate conversions. System 100 can restrict the search space of options (e.g. direct AMMI, routed AMM, direct CLOB, routed CLOB). This can be shown as a graph with input currency on the Y axis and the output currency on the X axis.

FIG. 5F is an example of a multiple market environment with direct and routed liquidity sources. In this example, there is a shown an indirect CLOB (BTC/USD) liquidity source in addition to a direct CLOB (ETH/BTC) liquidity source. In this example, the best price for the order may be achieved by using both direct and indirect liquidity sources. There may be multiple connector or routing currencies in different examples.

In another example of liquidity routing (see FIG. 5F), there may be five makers: 1. ETH/BTC central limit Order Book; 2. ETH/BTC AMM instructions 212; 3. ETH/USDC AMM instructions 212 (different market than taker); 4. BTC/USDC AMM instructions 212 (different market than taker); and 5. BTC/USDC central limit Order Book (different market than taker). The central limit Order Book fills can be reported as: 1. Taker: Buy 20 ETH for 1 BTC; 2. ETH/BTC central limit Order Book maker: Sell 9 ETH for 0.4 BTC; and 3. BTC/USDC central limit Order Book maker: Buy 0.3 BTC for 11,000 USDC. The three trades can be reported as: 1. Buy 20 ETH for 1 BTC taker; 2. Buy 0.6 BTC for 22,000 USDC maker; and 3. Sell 11 ETH for 22,000 USDC maker. The report quantities can be aggregated by market.

Every match has one taker and one or more makers. Orders may always get a fill. Takers may always get a fill since they are always orders. Makers may only get a fill if they are orders. With the AMMIs, the backend fills are not apparent to the taker. The system 100 may only report or send notification (e.g. via an API) one trade per market. This results in improved use of resources and scalability. The system 100 may report taker trades as-is. The system 100 may only report maker trades when the market doesn't match the taker. The system 100 may aggregate quantities to make sure only a single maker trade is reported per market.

The system 100 may not report trades for the portions of a match where the maker is the taker (e.g., where the account IDs match). The entity sending a taker order may be responsible for causing a match. All trades/fills may be considered to have been “caused by” the taker, even though the taker is not necessarily considered a direct counterparty to all trades in the match. For example, BTH sends a taker order that partially matches against a BTH AMM instruction 212, the system 100 may not report that quantity as a trade because it is not a trade though it would be a self-trade if it were reported. As another example, if a user sends a taker order, and the match is routed and involved a BTH BTC/USDC AMM instruction 212 and a BTH ETH/USDC AMM instruction 212. There is no BTH self-trade because the user caused the match.

A routed market combines two direct markets with a common quote currency. For example, an ETH-USDC and a BTC-USDC market can be combined together creating a routed ETH-BTC market. The ETH-USDC (BTC-USDC) is the base (quote) market. Executing an ETH-BTC buy trade entails an ETH-USDC buy trade and a BTC-USDC sell trade. The following conditions can be used to derive equations that can govern a routed market: 1) The quote currency (USDC for example) amount generated by a sell trade in the base/quote market must be equal to the amount used for a buy trade in the opposite market and vice versa; and 2) When executing a trade against the routed market up to a limit order price, the ratio of the direct markets end prices is equal to the limit price.

This provides the following equations. The implied routed liquidity would be:

$${l}_{routed} = \{ \begin{matrix}\frac{{l}_{base} {l}_{quote}}{{l}_{base} \sqrt{{p}_{ask}^{base}} + {l}_{quote} \sqrt{{p}_{bid}^{quote}}} , & for buy orders \\ \frac{{l}_{base} {l}_{quote}}{{l}_{base} \sqrt{{p}_{bid}^{base}} + {l}_{quote} \sqrt{{p}_{ask}^{quote}}} , & for sell orders\end{matrix}$$

When combined with direct liquidity, this yields:

$$l = {l}_{direct} + {l}_{routed}$$

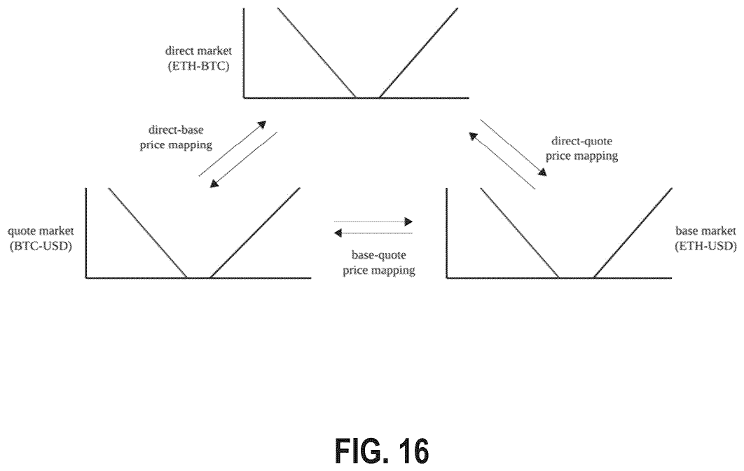

This total liquidity is used to fill orders similarly to how orders are filled in direct markets. In order to keep the three market prices in sync, the direct (ETH-BTC) price needs to be mapped into the base market (ETH-USDC) and quote market (BTC-USDC) prices, and vice-versa. FIG. 16 illustrates the mapping among the three markets graphically.

Liquidity is updated at the pivot prices (liquidity bucket end price and the next tier best price) of the direct, base, and quote markets.

A routed buy limit order with price Pₗ maps to a base market limit price of;

$$\sqrt{{P}_{l}^{B}} = \{ \begin{matrix}\sqrt{{P}_{l}} \frac{{l}_{B} \sqrt{{P}_{o}^{B}} + {l}_{Q} \sqrt{{P}_{b}^{Q}}}{{l}_{Q} \sqrt{{P}_{l}} + {l}_{Q}} , & if {l}_{B} > 0 \\ \sqrt{{P}_{l}} \sqrt{{P}_{b}^{Q}} , & if {l}_{B} = 0\end{matrix} ,$$

and a quote market limit price:

$$\sqrt{{P}_{l}^{Q}} = \{ \begin{matrix}\frac{{l}_{B} \sqrt{{P}_{o}^{B}} + {l}_{Q} \sqrt{{P}_{b}^{Q}}}{{l}_{Q} \sqrt{{P}_{l}} + {l}_{Q}} , & if {l}_{Q} > 0 \\ \frac{\sqrt{{P}_{o}^{B}}}{\sqrt{{P}_{l}}} , & if {l}_{Q} = 0\end{matrix} ,$$

Where l_{B} and l_{Q} are the base and quote markets liquidities, respectively. P_{b}^{B} and Pₒ^{B} are the base market best bid and offer. And similarly P_{b}^{Q} and Pₒ^{Q} are the quote market best bid and offer.

In addition, as illustrated in FIG. 16, prices between markets may need to be mapped. A buy price point in the quote market can be mapped to the base market using:

$$\sqrt{{P}^{B}} = \{ \begin{matrix}\sqrt{{P}_{o}^{B}} , & if {l}_{Q} ( \sqrt{{P}_{b}^{Q}} - \sqrt{{P}^{Q}} ) \leq 0 \\ ∞ , & if {l}_{B} = 0 \\ \frac{{l}_{Q}}{{l}_{B}} ( \sqrt{{P}_{b}^{Q}} - \sqrt{{P}^{Q}} ) + \sqrt{{P}_{o}^{B}} , & otherwise\end{matrix} ,$$

Equivalent equations for sell orders exist, but are not included here. The equations for sell orders are analogous with bid and ask prices interchanged. The inverse functions map the base and quote markets prices to the direct market price.

Filling a buy order in the routed market can follow similar steps to the direct market case with the following modifications: 1) The pivot price of the quote market can be found and mapped to the base market; 2) The mapped price is included as part of the base market pivot price logic; 3) If the mapped price is the minimum, the quote market is updated accordingly; and 4) Otherwise, the base market is updated then repeated.

In some embodiments, the system 100 can include a connector currency field to relate to a market when the market is a routed market. In some embodiments, the system 100 can change a market from a direct market to a routed market (and vice versa).

In some embodiments, the system 100 can handle the execution of routed market orders to source liquidity from a direct market's AMM 210 and not execute against the direct market's limit orders on that Order Book. Limit orders for a routed market can sit on its own book and can be executed against other limit orders that come in for that market. Switching an existing direct market to a routed market may not trigger a new market creation and may be an update on the existing market.

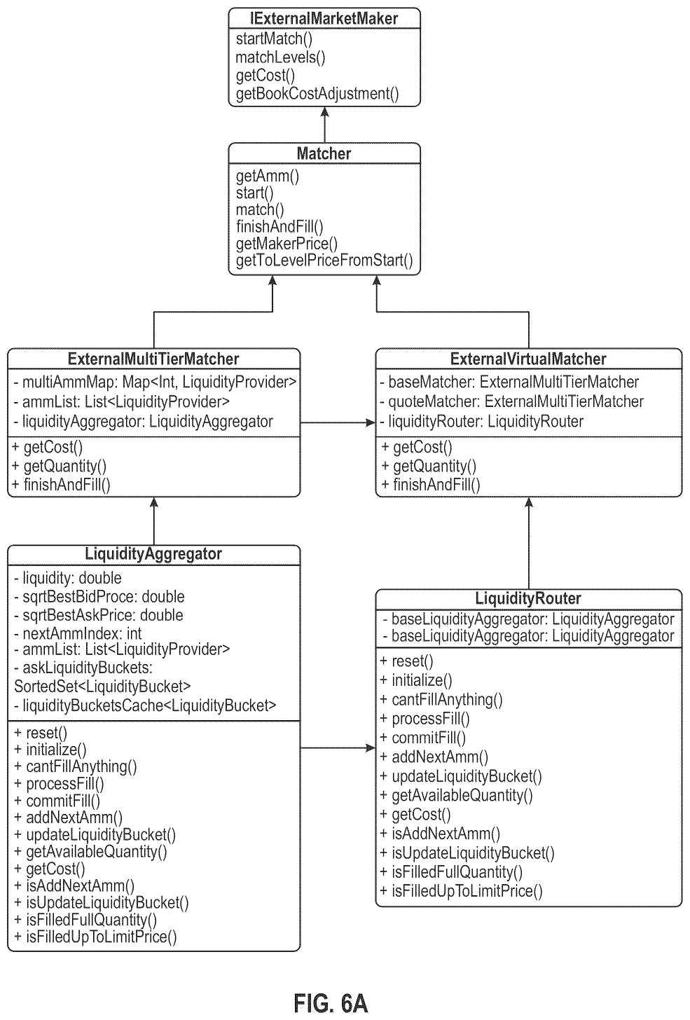

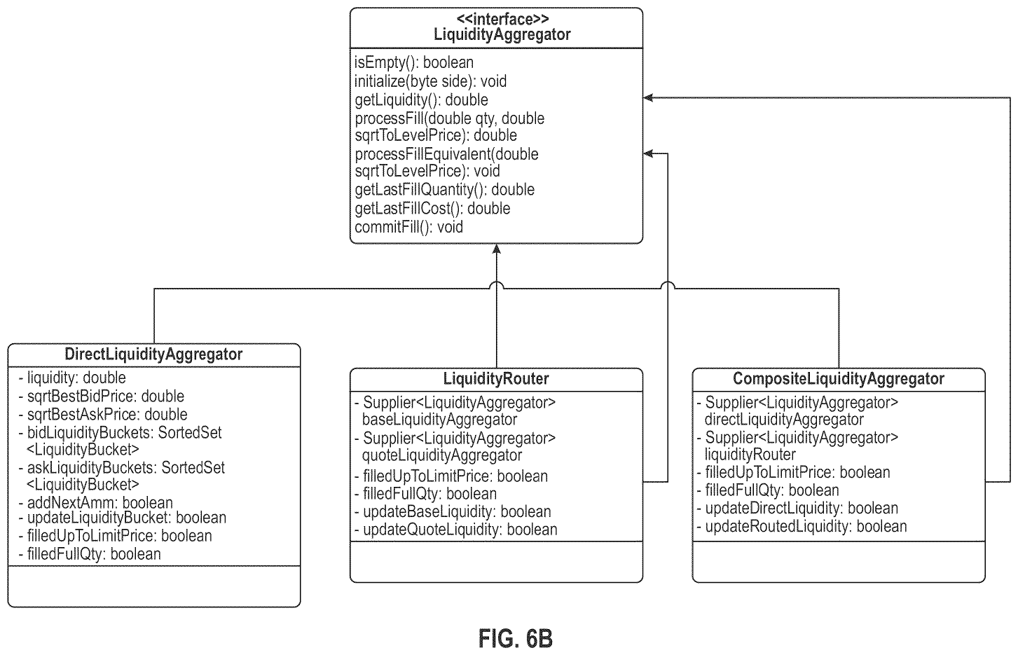

FIG. 6A shows a class diagram for liquidity routing according to some embodiments. The class diagram is a model to visually represent the structure and relationships of example classes that can be used to implement aspects of the system 100. The different example classes can include attributes and functions or operations. The diagram also shows relationships between the objects. That is, the example class diagram describes the structure of components of system 100 by showing classes, their attributes (or features), operations (or methods or functions), and the relationships among objects. A class can be a description of a group of objects. A class can have a class name, class attributes, and class operations.

The class diagram of FIG. 6A shows an example matcher implementation to handle virtual markets. For example, the matcher implementation includes different classes such as an external market maker class, a matcher class, an external virtual matcher class, an external multi-tier matcher class, a liquidity aggregator class, and a liquidity router class.

An external market maker class can include different operations such as start match, match levels, get cost, and get book cost adjustment. A matcher class can include different operations such as get AMM, start, match, finish and fill, get maker price, and get to level price from start. A matcher class can relate to or include a matching engine that can execute transactions (e.g., an order match). The matcher class can include different components such as: the fills processor, the matching engine, the dispatcher OMS drive, and integrated with the central limit order book. The matcher class can be configured to generate matches across different markets by using a connector currency.

An external virtual matcher class can include different attributes such as base matcher, quote matcher, and liquidity router. An external virtual matcher class can include different operations such as get cost, get quantity, and finish and fill.

An external multi-tier matcher class can include different attributes such as multi-AMM, AMM list, and liquidity aggregator. An external multi-tier matcher class can include different operations such as get cost, get quantity, and finish and fill.

A liquidity aggregator class can include different attributes such as liquidity, best bid price, best ask price, next AMM index, AMM list, ask liquidity bucket, and liquidity bucket cache. A liquidity aggregator class can include different operations such as reset, initialize, cannot fill anything, process fill, commit fill, add next AMM, update liquidity bucket, get available quantity, get cost, is add next AMM, is update liquidity bucket, is filled full quantity, is filled up to limit price, and so on.

A liquidity router class can include different attributes such as base liquidity aggregator, and so on. A liquidity router class can include different operations such as reset, initialize, cannot fill anything, process fill, commit fill, add next AMM, update liquidity bucket, get available quantity, get cost, is add next AMM, is update liquidity bucket, is filled full quantity, is filled up to limit price, and so on.

FIG. 6B shows an alternative embodiment of a class structure diagram with three classes and an interface. The LiquidityAggregator interface defines a set of methods that must be implemented by any class that aggregates liquidity. This interface ensures that all liquidity aggregators have a consistent set of functionalities. Specifically, the interface can check if the liquidity aggregator is empty, initialize the aggregator, return the current liquidity, process a fill given quantity and price, process an equivalent fill with a given price, return the quantity of the last fill, return the cost of the last fill, and commit the fill.

The DirectLiquidityAggregator class implements the LiquidityAggregator interface and is specifically designed to directly aggregate liquidity. It has several attributes that enable various aspects of liquidity management to store the current liquidity level, store the best bid price, store the best ask price, store a sorted set of liquidity buckets for bids, store a sorted set of liquidity buckets for asks, indicate whether to add the next AMM, indicate whether to update the liquidity bucket, indicate whether the liquidity has been filled up to the limit price, and indicate whether the full quantity has been filled.

The LiquidityRouter class also implements the LiquidityAggregator interface and is responsible for routing liquidity between different aggregators. It has several attributes that store various aspects of liquidity routing to supply the base liquidity aggregator, supply the quote liquidity aggregator, indicate whether the liquidity has been filled up to the limit price, indicate whether the full quantity has been filled, indicate whether to update the base liquidity, and indicate whether to update the quote liquidity.

The CompositeLiquidityAggregator class implements the LiquidityAggregator interface and is responsible for aggregating liquidity from multiple sources, including direct and composite aggregators. It has several attributes that store various aspects of composite liquidity management to supply the direct liquidity aggregator, supply the liquidity router, indicate whether the liquidity has been filled up to the limit price, indicate whether the full quantity has been filled, indicate whether to update the direct liquidity, and indicate whether to update the routed liquidity.

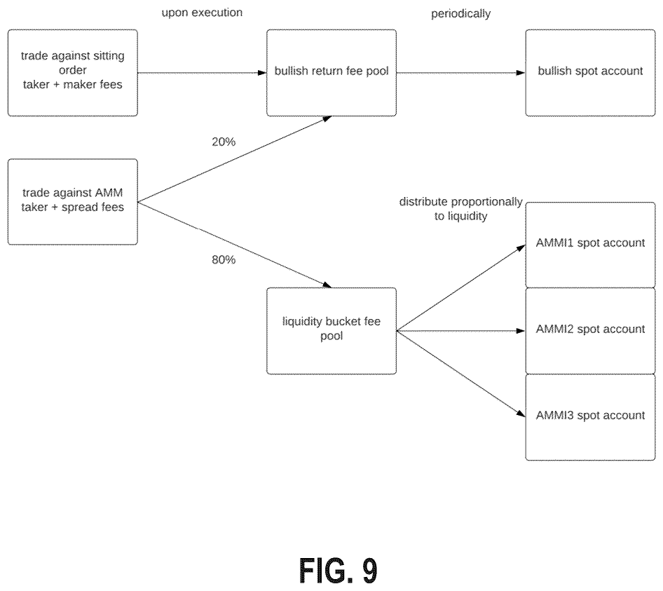

FIG. 9 shows a process diagram that indicates how trading fees are processed, according to some embodiments. This is an example for trading fees and other methods can be used for various embodiments. System 100 can collect and track fees relating to orders and transactions. System 100 can use fee pool(s) to collect fees and then periodically distribute the fees to spot accounts. For example, when trading against AMM instruction(s) 212 there can be a maker fee and a taker fee based on a percentage or proportional to how much liquidity is related to each spot account. Each liquidity bucket can have a fee pool to collect fees, and system 100 periodically reviews all pools and sends fees to AMM spot accounts proportionally to how much liquidity they have.

To close an AMM instruction 212, the system may calculate shares in the fee pools of the corresponding liquidity buckets. The system 100 can calculate base and quote amounts from liquidity, P, Pₗ, and Pᵤ. The system 100 can transfer to the base and quote spot accounts.

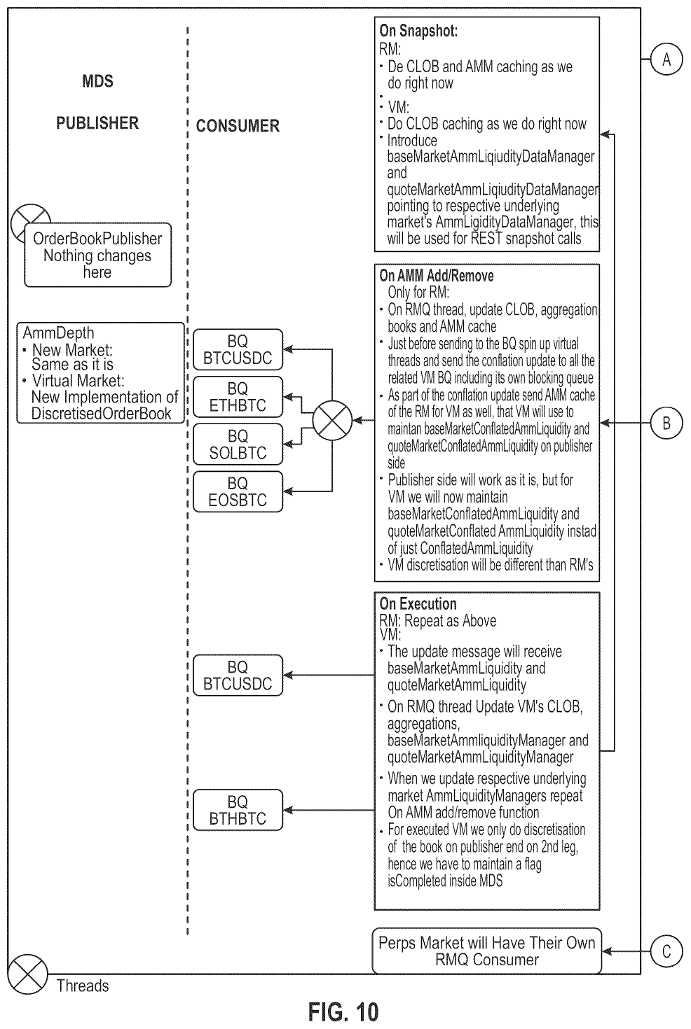

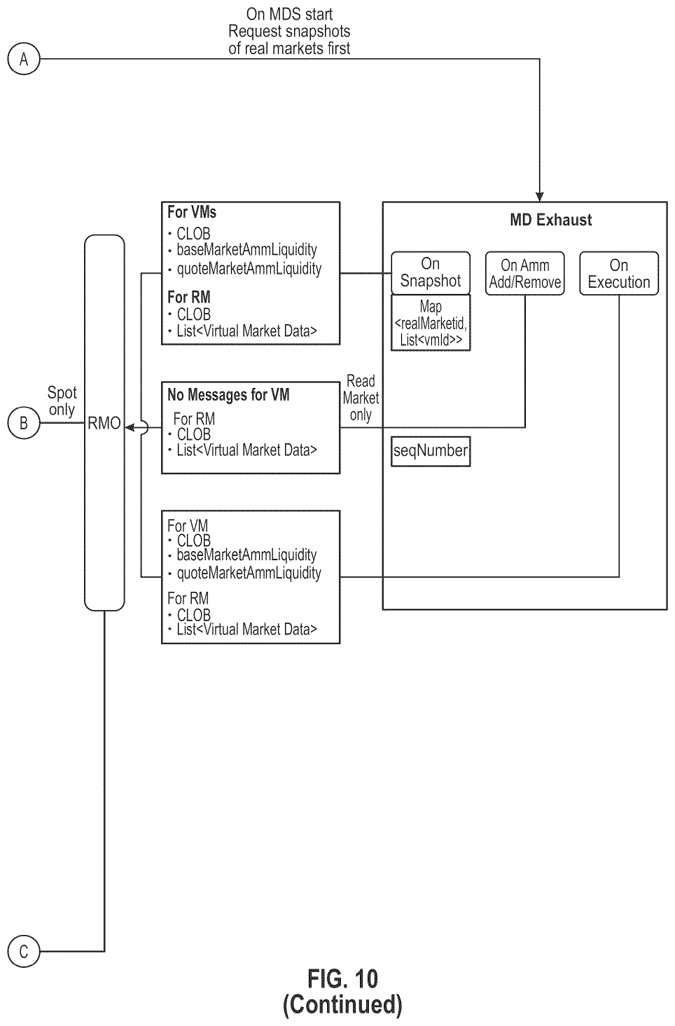

FIG. 10 shows a schematic diagram of market data liquidity routing design according to some embodiments. The example diagram shows a market data service with a publisher and consumer. The publisher can include an order book publisher and an AMM depth component for new markets and virtual markets (with an implementation of a discretized order book). The market data service communicates with a market data exhaust to request snapshots or datasets of real markets, and the market data exhaust provides such data in response to the request. The market data service can involve data relating to one or more real markets and one or more virtual markets. For Routed Liquidity, there are new fields such as: baseMarketAmmLiquidity (virtual market), quoteMarketAmmLiquidity (virtual market), virtualMarket with List<VirtualMarketData> (real market), Virtual Market Data with virtualMarketId and sequenceNumber, and so on.

While traditional systems only consider data of a single market, in virtual markets as depicted in FIG. 10, data from multiple markets are combined for liquidity routing. The AMM instructions are effectively filling orders in the virtual market and applying them to all markets that are routed through system 100. As soon as one market is repriced, every market that was routed through then becomes repriced as well.

FIG. 4 is a schematic diagram of an example embodiment of a distributed computer system 1000 for virtual markets. The distributed computer system 1000 can include and/or implement components of the system 100 of FIG. 1, for example.

The distributed computer system 1000 has a plurality of user devices 1002 having interfaces. The user devices 1002 connect to a processing system via network 1004 connections. The user devices 1002 are associated with user accounts of assets and can submit commands to system 100 for orders.

The distributed computer system 1000 has a processing system (e.g. system 100) that includes one or more processors 1006 and one or more memories 1008 coupled with the one or more processors 1006. The one or more memories 1008 store instructions for an engine for managing transactions of the user accounts. The one or more memories 1008 store instructions for virtual markets, market-maker 200 (AMM 210, AMM instructions 212), routed markets (e.g. liquidity routing), and so on. In some embodiments, the AMM is configured to discretize long and short positions, hold consolidated positions, and distribute the positions to components of the system. The one or more memories 1008 can store market data and Order Book depth charts.

In some embodiments, the processing system receives input from the interface of a user device 1002 for an order request for trading. The user devices 1002 can have an AMM interface 214 for providing data to configure parameters. In some embodiments, the processing system generates output relating to the user accounts and the order for transmission to an interface of a user device 1002 and displays visual elements relating to the accounts and order at the interface of the user device 1002. The processing system has a communication bus with a sequencer to route data and commands to the engine. In some embodiments, user device 1002 has a user interface to display visual elements for the user accounts, such as Order Book depth charts.

The distributed computer system 1000 provides for selective visual display of a multi-resolution order book for a distributed exchange platform and an interface for routed markets. The system 1000 connects multiple devices to receive commands and provide data at the interface of devices 1002. A processing system includes one or more processors 1006 and one or more memories 1008 coupled with the one or more processors 1006. The one or more memories 1008 storing an automated market maker 200 and automated market maker instructions, wherein the automated market maker instructions comprise code logic code that defines total quantities in a continuum of buy and sell orders within a specified price range. The processing system is configured to: provide a hybrid order book that integrates the automated market maker 200 with a central limit order book. The automated market maker 200 adjusts liquidity of the hybrid order book internally using the automated market maker instructions to manage buy and sell orders in the hybrid order book while avoiding latency issues and providing real-time data on the buy and sell orders, market depth, and price levels for assets. The hybrid order book immediately reprices outstanding orders after a trade and before another trade occurs. The processing system is configured to: provide one or more direct markets and one or more routed market for order execution wherein the routed market combines a plurality of markets based on a common quote asset, the routed market having a total liquidity of direct liquidity and routed liquidity, the routed liquidity being an implied liquidity value; execute one or more automated market maker instructions for the routed market based on an order indicating a base asset and a quote asset. The processing system is configured to: provide a selective visual display of a depth chart as a representation for the hybrid order book, wherein a visualization of the depth chart reflects market depth of the hybrid order book in real-time with visual elements corresponding to order book depth, wherein the interface displays visual elements for the routed virtual market.

In some embodiments, the hybrid order book comprises data for the processing system to generate visual elements representing supply and demand of an asset at various price points.

In some embodiments, the AMM interface 214 receives input data for parameters of the one or more automated market maker instructions. The processing system configures the automated market maker instructions based on the input data for the parameters, wherein a parameter relates to a desired bid-offer spread.

In some embodiments, an interface of device 1002 is configured to zoom into different resolutions or levels of a depth chart which triggers visualizations of the depth chart with different scales or price points along an axis centred at a selected price point.

In some embodiments, the automated market maker 200 selects one or more connector currencies for the one or more routed markets, and wherein the automated market maker 200 switches between the one or more direct markets and the one or more routed market for order execution.

In some embodiments, the automated market maker 200 applies spread for the bids and offers.

In some embodiments, the automated market maker instructions comprise a fixed spread, wherein the spread comprises a spread value for the fixed spread and a dynamic spread.

In some embodiments, the system 1000 has an automated market maker interface 214 to receive or set parameters to generate the automated market maker instructions. In some embodiments, the system has a derivative processor to manage perpetual positions. In some embodiments, the system has a spot processor. In some embodiments, the market-maker executes orders using spread tiers.

In some embodiments, the processing system provides one or more routed direct liquidity sources and one or more routed liquidity sources for order execution.

In some embodiments, the processing system generates depth charts for the order book, wherein the user interface of device 1002 displays visual elements for the user accounts and the depth charts for the order book.

In some embodiments, the automated market maker 200 is configured to discretize long and short positions; hold consolidated perpetual positions; and distribute the perpetual positions to components of the system.

In some embodiments, the system has a plurality of user devices 1002 in communication with the interface. The user devices 1002 are associated with user accounts, and interface 214 provides input data for the automated market maker instructions and configuration parameters. The processing system receives input from the interface for an order request to buy or sell a desired quantity of assets, and generates output relating to the order request and the user accounts for transmission to interfaces of the user devices 1002 and displays visual elements at the interfaces of the user devices 1002. A communication bus with a sequencer routes data and commands for the processing system.

In some embodiments, the market maker 200 executes orders using a plurality of spread tiers, each with a different spread value.

In some embodiments, the processing system generates a depth chart for the order book specific to a user device 1002. The interface displays visual elements for the user accounts and the depth chart for the order book. The depth chart comprises a bid/buy portion and an offer/sell portion, and the bid/buy portion shows the cumulative quantity of all buy orders placed on system at a given price point from the given price up to and including the best bid, wherein the offer/sell portion shows the cumulative value of the sell orders placed on system at a given price point from the given price down to and including the best offer, wherein an axis represents the price points at which buy and sell orders are placed for a particular market, and another axis representing the total volume that can be bought or sold, for the corresponding price.

In some embodiments, the automated market maker 200 is configured to discretize long and short positions; hold consolidated perpetual positions; and distribute the perpetual positions to components of the system.

These are example features of system 1000.

### Example Implementation Details

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references were made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

For example, and without limitation, the computing device may be a server, network appliance, set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the methods described herein

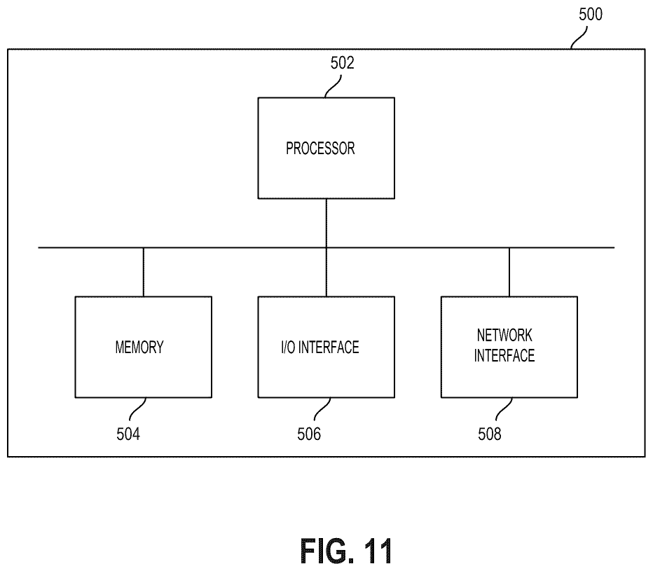

FIG. 11 is a schematic diagram of a computing device 500 that can be used to implement components of embodiments described herein. As depicted, computing device 500 includes at least one processor 502, memory 504, at least one I/O interface 506, and at least one network interface 508.

For simplicity only one computing device 500 is shown but system may include more computing devices 500 operable by users to access remote network resources and exchange data. The computing devices 500 may be the same or different types of devices. The computing device 500 at least one processor, a data storage device (including volatile memory or non-volatile memory or other data storage elements or a combination thereof), and at least one communication interface. The computing device components may be connected in various ways including directly coupled, indirectly coupled via a network, and distributed over a wide geographic area and connected via a network (which may be referred to as “cloud computing”).

Each processor 502 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 504 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 506 enables computing device 500 to interconnect with one or more input devices, such as a keyboard, mouse, camera, touch screen and a microphone, or with one or more output devices such as a display screen and a speaker.

Each network interface 508 enables computing device 500 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

The foregoing discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

As can be understood, the examples described above and illustrated are intended to be exemplary only. The scope is indicated by the appended claims.

What is claimed is:

1. A computer system for selective visual display of a multi-resolution order book for a distributed exchange platform and an interface for routed markets, wherein the distributed exchange platform connects multiple devices to receive commands and provide data at the interface, the system comprising:
a processing system that includes one or more processors and one or more memories coupled with the one or more processors, the one or more memories storing an automated market maker and automated market maker instructions, wherein the automated market maker instructions comprise code logic code that defines total quantities in a continuum of buy and sell orders within a specified price range, wherein the processing system is configured to:
provide a hybrid order book that integrates the automated market maker with a central limit order book, wherein the automated market maker adjusts liquidity of the hybrid order book internally using the automated market maker instructions to manage buy and sell orders in the hybrid order book while avoiding latency issues and providing real-time data on the buy and sell orders, market depth, and price levels for assets, wherein the hybrid order book immediately reprices outstanding orders after a trade and before another trade occurs;
provide one or more direct markets and one or more routed market for order execution wherein the routed market combines a plurality of markets based on a common quote asset, the routed market having a total liquidity of direct liquidity and routed liquidity, the routed liquidity being an implied liquidity value;
execute one or more automated market maker instructions for the routed market based on an order indicating a base asset and a quote asset;
provide a selective visual display of a depth chart as a representation for the hybrid order book, wherein a visualization of the depth chart reflects market depth of the hybrid order book in real-time with visual elements corresponding to order book depth, wherein the interface displays visual elements for the routed virtual market.

2. The system of claim 1 wherein the hybrid order book comprises data for the processing system to generate visual elements representing supply and demand of an asset at various price points.

3. The system of claim 1 wherein the interface receives input data for parameters of the one or more automated market maker instructions, and wherein the processing system is configured to configure the automated market maker instructions based on the input data for the parameters, wherein a parameter relates to a desired bid-offer spread.

4. The system of claim 1 wherein the interface is configured to zoom into different resolutions or levels of a depth chart which triggers visualizations of the depth chart with different scales or price points along an axis centred at a selected price point.

5. The computer system of claim 1, wherein the automated market maker selects one or more connector currencies for the one or more routed markets, and wherein the automated market maker switches between the one or more direct markets and the one or more routed market for order execution.

6. The system of claim 1 wherein the automated market maker applies spread for the bids and offers.

7. The system of claim 6 wherein the automated market maker instructions comprise a fixed spread, wherein the spread comprises a spread value for the fixed spread and a dynamic spread.

8. The system of claim 1 further comprises an automated market maker interface to receive or set parameters to generate the automated market maker instructions.

9. The system of claim 1 further comprising a derivative processor to manage perpetual positions.

10. The system of claim 1 further comprising a spot processor.

11. The computer system of claim 1, wherein the market-maker executes orders using spread tiers.

12. The computer system of claim 1, wherein the processing system provides one or more routed direct liquidity sources and one or more routed liquidity sources for order execution.

13. The computer system of claim 1, wherein the processing system generates depth charts for the order book, wherein the user interface displays visual elements for the user accounts and the depth charts for the order book.

14. The computer system of claim 1, wherein the automated market maker is configured to discretize long and short positions; hold consolidated perpetual positions; and distribute the perpetual positions to components of the system.

15. The computer system of claim 1, further comprising:
a plurality of user devices in communication with the interface, the user devices being associated with user accounts, wherein a user device provides input data for the automated market maker instructions and configuration parameters;
wherein the processing system receives input from the interface for an order request to buy or sell a desired quantity of assets;
wherein the processing system generates output relating to the order request and the user accounts for transmission to interfaces of the user devices and displays visual elements at the interfaces of the user devices; and
wherein a communication bus with a sequencer routes data and commands for the processing system.

16. The computer system of claim 1, wherein the market maker executes orders using a plurality of spread tiers, each with a different spread value.

17. The computer system of claim 1, wherein the processing system generates a depth chart for the order book specific to a user device, wherein the interface displays visual elements for the user accounts and the depth chart for the order book, wherein the depth chart comprises a bid/buy portion and an offer/sell portion, wherein the bid/buy portion shows the cumulative quantity of all buy orders placed on system at a given price point from the given price up to and including the best bid, wherein the offer/sell portion shows the cumulative value of the sell orders placed on system at a given price point from the given price down to and including the best offer, wherein an axis represents the price points at which buy and sell orders are placed for a particular market, and another axis representing the total volume that can be bought or sold, for the corresponding price.

18. The computer system of claim 1, wherein the automated market maker is configured to discretize long and short positions; hold consolidated perpetual positions; and distribute the perpetual positions to components of the system.

19. A computer implemented method for selective visual display of a multi-resolution order book for a distributed exchange platform and an interface for routed markets, wherein the distributed exchange platform connects multiple devices to receive commands and provide data at the interface, the method comprising:
generating an automated market maker and automated market maker instructions, wherein the automated market maker instructions comprise code logic code that defines total quantities in a continuum of buy and sell orders within a specified price range;
providing a hybrid order book that integrates the automated market maker with a central limit order book, wherein the automated market maker adjusts liquidity of the hybrid order book internally using the automated market maker instructions to manage buy and sell orders in the hybrid order book while avoiding latency issues and providing real-time data on the buy and sell orders, market depth, and price levels for assets, wherein the hybrid order book immediately reprices outstanding orders after a trade and before another trade occurs;
providing one or more direct markets and one or more routed market for order execution wherein the routed market combines a plurality of markets based on a common quote asset, the routed market having a total liquidity of direct liquidity and routed liquidity, the routed liquidity being an implied liquidity value;
executing one or more automated market maker instructions for the routed market based on an order indicating a base asset and a quote asset; and
generating a selective visual display of a depth chart as a representation for the hybrid order book, wherein a visualization of the depth chart reflects market depth of the hybrid order book in real-time with visual elements corresponding to order book depth, wherein the interface displays visual elements for the routed virtual market.

20. A non-transitory machine readable medium having stored thereon a plurality of instructions that, when executed by at least one computing device, cause the at least one computing device to perform a method comprising:
generating an automated market maker and automated market maker instructions, wherein the automated market maker instructions comprise code logic code that defines total quantities in a continuum of buy and sell orders within a specified price range;
providing a hybrid order book that integrates the automated market maker with a central limit order book, wherein the automated market maker adjusts liquidity of the hybrid order book internally using the automated market maker instructions to manage buy and sell orders in the hybrid order book while avoiding latency issues and providing real-time data on the buy and sell orders, market depth, and price levels for assets, wherein the hybrid order book immediately reprices outstanding orders after a trade and before another trade occurs;
providing one or more direct markets and one or more routed market for order execution wherein the routed market combines a plurality of markets based on a common quote asset, the routed market having a total liquidity of direct liquidity and routed liquidity, the routed liquidity being an implied liquidity value;
executing one or more automated market maker instructions for the routed market based on an order indicating a base asset and a quote asset; and
generating a selective visual display of a depth chart as a representation for the hybrid order book, wherein a visualization of the depth chart reflects market depth of the hybrid order book in real-time with visual elements corresponding to order book depth, wherein the interface displays visual elements for the routed virtual market.
